(19) United States
(12) Patent Application Publication
(10) Pub. No.: US 2024/0405805 A1
(43) Pub. Date: Dec. 5, 2024

(54) WIRELESS SECURE COMMUNICATION METHOD USING RECONFIGURABLE INTELLIGENT SURFACE-NON-ORTHOGONAL MULTIPLE ACCESS UNDER COMPLEX CHANNEL CONDITIONS

(71) Applicant: Taiyuan University of Science and Technology, Taiyuan (CN)

(72) Inventors: Meiling LI, Taiyuan (CN); Ruifen MA, Taiyuan (CN); Zhaoming LU, Taiyuan (CN); Heyong HAN, Taiyuan (CN); Chang LIU, Taiyuan (CN)

(21) Appl. No.: 18/610,234

(22) Filed: Mar. 19, 2024

(30) Foreign Application Priority Data
Apr. 25, 2023 (CN) 202310455947.0

(51) Int. Cl. H04B 7/04; H04B 17/336; H04L 5/00

(52) U.S. Cl. CPC H04B 7/04013; H04B 17/336; H04L 5/0005

(57) ABSTRACT

A wireless secure communication method based on RIS-NOMA under complex channel conditions, the method including: firstly, an intelligent surface is assume to be disposed between the base station and legitimate NOMA users, and between the base station and eavesdroppers; the signal to interference plus distortion noise ratio (SIDNR) for the legitimate NOMA user and the eavesdropper is calculated in the presence of RHI in the system; secondly, considering shadow fading and to simplify the overly complex calculation process, the probability density function and cumulative distribution function of the shadow fading are approximated; finally, the outrage probability and intercept probability of the legitimate users and eavesdroppers are calculated.

### CROSS-REFERENCE TO RELATED APPLICATIONS

Pursuant to 35 U.S.C. § 119 and the Paris Convention Treaty, this application claims foreign priority to Chinese Patent Application No. 202310455947.0 filed Apr. 25, 2023, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, MA 02142.

### BACKGROUND

The disclosure relates to the field of wireless communication, and more particularly to a wireless secure communication method using reconfigurable intelligent surface-non-orthogonal multiple access (RIS-NOMA) under complex channel conditions.

Reconfigurable intelligent surface (RIS) is a revolutionary technology in the field of wireless communications that can independently regulate the phase shift of electromagnetic signals incident on its own surface, thereby effectively improving the transmission environment and performance when the direct link of the communication system is blocked.

However, the sole use of RIS communication is not sufficient to meet the demand of massive access for 6G communication, and the power-domain non-orthogonal multiple access (NOMA) technique not only realizes massive multiple access, but also maintains user fairness compared with orthogonal multiple access schemes. Therefore, the combination of power-domain NOMA and RIS is expected to be widely used in the upcoming 6G era.

NOMA and RIS technologies are increasingly used in a wide range of complex and diverse scenarios. In practical communication systems, the transceiver hardware of wireless nodes is inevitably subject to various types of losses. Although these losses can be mitigated by some compensation and calibration algorithms, there are still incorrect calibration, so that the hardware loss cannot be completely removed. Hardware loss also has a significant adverse impact on system performance.

### SUMMARY

In NOMA systems with eavesdroppers and obstructed or blocked direct links, to improve the physical layer security performance of the system, the disclosure provides a wireless secure communication method based on RIS-NOMA under complex channel conditions. Firstly, an intelligent surface is assume to be disposed between the base station and legitimate NOMA users, and between the base station and eavesdroppers; the signal to interference plus distortion noise ratio (SIDNR) for the legitimate NOMA user and the eavesdropper is calculated in the presence of RHI in the system; secondly, considering shadow fading and to simplify the overly complex calculation process, the probability density function and cumulative distribution function of the shadow fading are approximated; finally, the outrage probability and intercept probability of the legitimate users and eavesdroppers are calculated.

The disclosure provides a wireless secure communication method using reconfigurable intelligent surface-non-orthogonal multiple access (RIS-NOMA) under complex channel conditions; the RIS-NOMA refers to a RIS-NOMA communication system comprising: a base station (BS), a reconfigurable intelligent surface (RIS), a legitimate NOMA user, and an eavesdropper (Eve); the legitimate NOMA user comprises a legitimate remote user Dₘ, and a legitimate near user D″, and the base station communicates with the reconfigurable intelligent surface (RIS); the reconfigurable intelligent surface (RIS) communicates with the legitimate NOMA user; the eavesdropper (Eve) intercepts a signal transmitted by the RIS; an arbitrary channel link obeys k-u shadow fading; each node in the RIS-NOMA communication system encounters a residual hardware impairment (RHI), and the method comprising:
1) calculating a signal to interference plus distortion noise ratio (SIDNR) for the legitimate NOMA user and the eavesdropper in the presence of RHI in the system;
2) approximating a probability density function and cumulative distribution function for the κ-μ shadow fading;
3) calculating an outrage probability of the legitimate NOMA user and an intercept probability of the eavesdropper; and
4) transforming the calculation of the outrage probability of the legitimate NOMA user and the intercept probability of the eavesdropper into solving a cumulative distribution function of equivalent channel coefficients of corresponding joint channels, whereby measuring physical layer secure transmission performance of the system.

In a class of this embodiment, 1) is performed as follows:
defining a channel coefficient from the base station to an ith RIS reflecting surface in the system as hₛᵢ, and channel coefficients from the RIS to the legitimate NOMA user and to the eavesdropper as g_{id}, u∈(n,m) and gᵢₑ, respectively;
in the NOMA system, because the legitimate near user Dₙ is closer to the base station BS than the legitimate remote user Dₘ, with stronger channels; according to the NOMA principle, less transmission power is allocated to the legitimate near user Dₙ, and more power is allocated to the legitimate remote user Dₘ; for the legitimate near user Dₙ, due to being close to the base station, the channel gain is relatively large, and the corresponding allocated power is relatively small, so the signal strength thereof is also relatively small. For the legitimate near user Dₙ, the channel gain weak signals xₘ are eliminated through SIC.

When the legitimate near user Dₙ detects a weak signal xₘ, the signal to interference plus distortion to noise ratio SIDNR is expressed as:

$${γ}_{{D}_{n} \to {D}_{m}} = \frac{{α}_{m} {{A}_{n}}^{2}}{{{A}_{n}}^{2} ( {α}_{n} + {ρ}_{{SD}_{n}}^{2} ) + \frac{{d}_{B}^{τ} {d}_{R , n}^{τ}}{{ρ}_{S}}} ; \qquad ( 1 )$$

where, αₘ and αₙ represent power distribution coefficients of the legitimate remote user Dₘ and the legitimate near user Dₙ, respectively, and

$${α}_{n} < {α}_{m} , {α}_{m} + {α}_{n} = 1 ; {ρ}_{S} = \frac{{P}_{S}}{{σ}_{D}^{2}}$$

represents an average signal-to-noise ratio of a legal link, Ps is a transmit power of BS, and is an additive white Gaussian noise channel variance; ρ_{SD}_{ₙ} represents an overall RHI level of a link BS→Dₙ; Aₙ=Σᵢ₌₁^{N}|hₛᵢ∥g_{id}_{ₙ}| represents a joint channel coefficient of the link BS→Dₙ; hₛᵢ is a channel coefficient of a link BS→RIS; g_{id}_{ₙ} is a channel coefficient of a link RIS→Dₙ; |·| represents modeling; dₙ and d_{R,n} represent a distance from the base station to the RIS and a distance from the RIS to the legitimate near user Dₙ, respectively; and τ represents a path fading index;
through SIC technology, the SIDNR of D, decoding its own signal is given by the following equation:

$${γ}_{{D}_{n}} = \frac{{α}_{n} {{A}_{n}}^{2}}{{{A}_{n}}^{2} {ρ}_{{SD}_{n}}^{2} + \frac{{d}_{B}^{τ} {d}_{R , n}^{τ}}{{ρ}_{S}}} ; \qquad ( 2 )$$

when Dₘ decodes its own signal, a signal xₙ with strong channel gain is considered as noise, and SIDNR is represented as follows:

$${γ}_{{D}_{m}} = \frac{{α}_{m} {{A}_{m}}^{2}}{{{A}_{m}}^{2} ( {α}_{n} + {ρ}_{{SD}_{m}}^{2} ) + \frac{{d}_{B}^{τ} {d}_{R , m}^{τ}}{{ρ}_{S}}} ; \qquad ( 3 )$$

where Aₘ=Σᵢ₌₁^{N}|hₛᵢ∥g_{id}_{ₘ}|; g_{id}_{ₘ} is a channel coefficient of a link RIS→Dₘ;
when the eavesdropper intercepts the signals xₙ and xₘ respectively, the obtained SIDNR is expressed as follows:

$${γ}_{{E}_{n}} = \frac{{α}_{n} {A}_{e}^{2}}{{A}_{e}^{2} {ρ}_{SE}^{2} + \frac{{d}_{B}^{τ} {d}_{R , e}^{τ}}{{ρ}_{E}}} \qquad ( 4 )$$

$${γ}_{{E}_{m}} = \frac{{α}_{m} {A}_{e}^{2}}{{A}_{e}^{2} ( {α}_{n} + {ρ}_{SE}^{2} ) + \frac{{d}_{B}^{τ} {d}_{R , e}^{τ}}{{ρ}_{E}}} \qquad ( 5 )$$

$${ρ}_{E} = \frac{{P}_{S}}{{σ}_{E}^{2}}$$

represents SNR of an eavesdropping link; Aₑ=Σᵢ₌₁^{N}|hₛᵢ∥gᵢₑ|; gᵢₑ represents a joint channel coefficient of a link RIS→Eve; σ_{E}² represents an additive white Gaussian noise channel variance of the eavesdropper; PSE represents an overall RHI level of a link BS→Eve; and d_{R,e} represents a distance from the RIS to the eavesdropper.

In a class of this embodiment, 2) is performed as follows:
SIDNR of the legitimate NOMA user and the eavesdropper contains Aᵤ=Σᵢ₌₁^{N}|hₛᵢ∥g_{id}_{ᵤ}|, u∈(n,m) and Aₑ=Σᵢ₌₁^{N}|hₛᵢ∥gᵢₑ| as equivalent channel coefficients for corresponding joint channels; assuming that envelopes |hₛᵢ|, |g_{id}|, u∈(n,m) and |gᵢₑ| of all instantaneous channel coefficients are subject to independent and identically distributed k-μ shadow fading, and X represents the envelopes |hₛᵢ|, |g_{id}|, u∈(n,m) and |gᵢₑ| of instantaneous channel coefficients, the cumulative distribution functions and probability density functions thereof are represented as follows:

$${F}_{X} ( x ) = \frac{{μ}^{μ - 1} {{m}^{m} ( 1 + k )}^{μ}}{Γ ( μ ) {( μ k + m )}^{m}} {( \frac{1}{R} )}^{2 μ} {x}^{2 μ} {Φ}_{2} ( μ - m , m , μ + 1 ; - \frac{μ ( 1 + k ) {x}^{2}}{{R}^{2}} , - \frac{μ ( 1 + k )}{{R}^{2}} \frac{m {x}^{2}}{μ k + m} ) \qquad ( 6 )$$

$$\begin{matrix}{f}_{X} ( x ) = = \frac{2 {μ}^{μ} {{m}^{m} ( 1 + k )}^{μ}}{Γ ( μ ) {( μ k + m )}^{m}} ( \frac{1}{{R}^{2 μ}} ) \\ {x}^{2 μ - 1} exp ( - \frac{μ ( 1 + k )}{{R}^{2}} {x}^{2} ) {}_{1} {F}_{1} ( m , μ ; \frac{{μ}^{2} k ( 1 + k )}{( μ k + m ) {R}^{2}} {x}^{2} ) \\ = \frac{2 {a}^{μ}}{Γ ( μ ) {b}^{m}} {x}^{2 μ - 1} exp ( - ax ) {}_{1} {F}_{1} ( m , μ ; \frac{{μ}^{2} k ( 1 + k )}{( μ k + m ) {R}^{2}} {x}^{2} )\end{matrix} \qquad ( 7 )$$

Γ(·), Φ₂(·) and ₁F₁(·) are defined as a Gamma function, binary confluence hypergeometric function, and confluence hypergeometric function, respectively;

$$a = \frac{μ ( 1 + k )}{Ω} , b = \frac{μ k + m}{m} ;$$

k is a ratio of a total power of dispersed components to dominant sight components, μ is a total number of multipath clusters, m is a fading degree parameter, and R is an average power of the channel;
to simplify calculation, the cumulative distribution function and probability density function of the k-μ shadow distribution are approximated as follows:

$${F}_{X} ( x ) \approx \frac{{α}^{α} {x}^{1 α}}{Γ ( α + 1 ) {R}^{2 a}} {}_{1} {F}_{1} ( α , α + 1 , \frac{- {x}^{2} α}{{R}^{2}} ) \qquad ( 8 )$$

$${f}_{X} ( x ) \approx \frac{2 {α}^{α} {x}^{2 α - 1}}{{R}^{2 α} Γ ( α )} exp ( \frac{- {x}^{2}}{{R}^{2}} α ) ; \qquad ( 9 )$$

$$and α = \frac{m {μ ( 1 + k )}^{2}}{m + μ {k}^{2} + 2 m k}$$

In a class of this embodiment, in 3), the outrage probability of the legitimate NOMA user is calculated as follows:
when a channel capacity of a main channel is less than a set threshold Rᵤ, and u∈(n,m), an interrupt event occurs, Cᵤ=½log₂(1+γ_{D}_{ₛ}) represents the channel capacity of the main channel, and the outrage probability of a legitimate NOMA user Dᵤ is expressed as follows:

$$\begin{matrix}{P}_{out , n} = Pr \{ {C}_{u} \leq {R}_{u} \} \\ = Pr \{ {γ}_{{D}_{u}} \leq {2}^{2 {R}_{u}} - 1 \} \\ = {F}_{{γ}_{{D}_{u}}} ( {2}^{2 {R}_{u}} - 1 )\end{matrix} \qquad ( 10 )$$

3.1) the outrage probability of the legitimate near user Dₙ:

$$\begin{matrix}{P}_{out , n} = Pr \{ {C}_{n} \leq {R}_{n} \} \\ = {F}_{{γ}_{{D}_{n}}} ( {2}^{2 {R}_{n}} - 1 )\end{matrix} ; \qquad ( 11 )$$

F_{γD}_{ₙ} (x) is expressed as:

$$\begin{matrix}{F}_{{γ}_{{D}_{m}}} ( x ) = Pr \{ {γ}_{{D}_{n}} \leq x \} \\ = Pr \{ \frac{{α}_{n} {A}_{n}^{2}}{{A}_{n}^{2} {ρ}_{S {D}_{n}}^{2} + \frac{{d}_{B}^{τ} {d}_{R , n}^{τ}}{{ρ}_{s}}} \leq x \} \\ = Pr \{ {A}_{n}^{2} \leq \frac{{d}_{B}^{τ} {d}_{R , n}^{τ} x}{{ρ}_{S} ( {α}_{n} - x {ρ}_{S {D}_{n}}^{2} )} \} \\ = {F}_{{A}_{n}} ( \sqrt{\frac{{d}_{B}^{τ} {d}_{R , n}^{τ} x}{{ρ}_{S} ( {α}_{n} - x {ρ}_{S {D}_{n}}^{2} )}} )\end{matrix} \qquad ( 12 )$$

F_{A}_{ₙ} (x) represents a cumulative distribution function of Aₙ;
3.2) the outrage probability of the legitimate remote user Dₘ;

$$\begin{matrix}{P}_{out} , m = Pr \{ {C}_{m} \leq {R}_{m} \} \\ = {F}_{{γ}_{{D}_{m}}} ( {2}^{2 {R}_{m}} - 1 )\end{matrix} \qquad ( 13 )$$

F_{γD}_{ₘ} (x) is expressed as:

$$\begin{matrix}{F}_{{γ}_{{D}_{m}}} ( x ) = Pr \{ {γ}_{{D}_{m}} \leq x \} \\ = Pr \{ \frac{{α}_{m} {A}_{m}^{2}}{{A}_{m}^{2} ( {α}_{n} + {ρ}_{S {D}_{m}}^{2} ) + \frac{{d}_{B}^{τ} {d}_{R , m}^{τ}}{{ρ}_{S}}} \leq x \} \\ = Pr \{ {A}_{m}^{2} \leq \frac{{d}_{B}^{τ} {d}_{R , m}^{τ} x}{{ρ}_{S} ( {α}_{m} - x ( {α}_{n} + {ρ}_{S {D}_{m}}^{2} ) )} \} \\ = {F}_{{A}_{m}} ( \sqrt{\frac{{d}_{B}^{τ} {d}_{R , m}^{τ} x}{{ρ}_{S} ( {α}_{m} - x ( {α}_{n} + {ρ}_{S {D}_{m}}^{2} ) )}} )\end{matrix} \qquad ( 14 )$$

F_{A}_{ₘ} (x) represents a cumulative distribution function of Aₘ.

In a class of this embodiment, in 3), the intercept probability of the eavesdropper is calculated as follows:
when a channel capacity of an eavesdropping channel is greater than a transmission rate, an interception event occurs; C_{E}_{ₐ}=½log₂(1+γ_{DE}_{ₐ}) represents the channel capacity of the eavesdropping channel, and the intercept probability that the eavesdropper intercepts a legitimate user's information is denoted as follows:

$$\begin{matrix}{P}_{int , n} = {P}_{r} ( {C}_{{E}_{u}} > {R}_{u} ) \\ = 1 - {P}_{r} ( {C}_{{E}_{u}} \leq {R}_{u} ) \\ = 1 - {P}_{r} ( {γ}_{{E}_{u}} \leq {2}^{2 {R}_{u}} - 1 ) \\ = 1 - {F}_{{γ}_{{E}_{u}}} ( {2}^{2 {R}_{u}} - 1 )\end{matrix} ; \qquad ( 15 )$$

3.3) the intercept probability when the eavesdropper intercepts the legitimate near user Dₙ:

$$\begin{matrix}{P}_{int , n} = {P}_{r} ( {C}_{{E}_{n}} > {R}_{n} ) \\ = 1 - {P}_{r} ( {C}_{{E}_{n}} \leq {R}_{n} ) \\ = 1 - {F}_{{γ}_{{E}_{n}}} ( {2}^{2 {R}_{n}} - 1 )\end{matrix} ; \qquad ( 16 )$$

F_{γE}_{ₙ} (x) is expressed as:

$$\begin{matrix}{F}_{{γ}_{{E}_{n}}} ( x ) = Pr \{ {γ}_{{E}_{n}} \leq x \} \\ = Pr \{ \frac{{α}_{n} {A}_{e}^{2}}{{A}_{e}^{2} {ρ}_{S E}^{2} + \frac{{d}_{B}^{τ} {d}_{R , e}^{τ}}{{ρ}_{E}}} \leq x \} \\ = Pr \{ {A}_{e}^{2} \leq \frac{{d}_{B}^{τ} {d}_{R , e}^{τ} x}{{ρ}_{E} ( {α}_{n} - x {ρ}_{S E}^{2} )} \} \\ = {F}_{{A}_{e}} ( \sqrt{\frac{{d}_{B}^{τ} {d}_{R , e}^{τ} x}{{ρ}_{E} ( {α}_{n} - x {ρ}_{S E}^{2} )}} )\end{matrix} ; \qquad ( 17 )$$

F_{A}_{ₑ} (x) represents a cumulative distribution function of Aₑ;
3.4) the intercept probability when the eavesdropper intercepts the legitimate remote user Dₘ:

$$\begin{matrix}{P}_{int , m} = {P}_{r} ( {C}_{{E}_{m}} > {R}_{m} ) \\ = 1 - {P}_{r} ( {C}_{{E}_{m}} \leq {R}_{m} ) \\ = 1 - {F}_{{γ}_{{E}_{m}}} ( {2}^{2 {R}_{m}} - 1 )\end{matrix} \qquad ( 18 )$$

F_{γE}_{ₘ} (x) is expressed as:

$$\begin{matrix}{F}_{{γ}_{{E}_{m}}} ( x ) = Pr \{ {γ}_{{E}_{m}} \leq x \} \\ = Pr \{ \frac{{α}_{m} {A}_{e}^{2}}{{A}_{e}^{2} ( {α}_{n} + {ρ}_{SE}^{2} ) + \frac{{d}_{B}^{τ} {d}_{R , e}^{τ}}{{ρ}_{E}}} \leq x \} \\ = Pr \{ {A}_{e}^{2} \leq \frac{{d}_{B}^{τ} {d}_{R , e}^{τ} x}{{ρ}_{E} ( {α}_{m} - x ( {α}_{n} + {ρ}_{SE}^{2} ) )} \} \\ = {F}_{{A}_{e}} ( \sqrt{\frac{{d}_{B}^{τ} {d}_{R , e}^{τ} x}{{ρ}_{E} ( {α}_{m} - x ( {α}_{n} + {ρ}_{SE}^{2} ) )}} )\end{matrix} \qquad ( 19 )$$

F_{A}_{ₑ} (x) represents a cumulative distribution function of Aₑ.

In a class of this embodiment, 4) is performed as follows:
given Aᵤ=Σᵢ₌₁^{N}|hₛᵢ∥g_{id}_{ᵤ}|, let Xᵢ=Xᵢ₁Xᵢ₂=|hₛᵢ∥g_{id}_{ᵤ}|, and Aᵤ=Σᵢ₌₁^{N}Xᵢ, approximating PDF and CDF of Aᵤ as follows:

$${f}_{{A}_{u}} ( x ) = {a}_{1} {G}_{1 , 2}^{2 , 0} ( \frac{x}{{a}_{2}} \vert \begin{matrix}- ; {a}_{3} \\ {a}_{4} ; {a}_{5}\end{matrix} ) \qquad ( 20 )$$

$${F}_{{A}_{u}} ( x ) \approx {a}_{1} {a}_{2} {G}_{2 , 3}^{2 , 1} ( \frac{x}{{a}_{2}} \vert \begin{matrix}1 ; {a}_{3} + 1 \\ {a}_{4} + 1 ; {a}_{5} + 1 ; 0\end{matrix} ) , x \geq 0 \qquad ( 21 )$$

$${a}_{1} = \frac{Γ ( {a}_{3} + 1 )}{{a}_{2} Γ ( {a}_{4} + 1 ) Γ ( {a}_{5} + 1 )} \qquad ( 22 )$$

$${a}_{2} = \frac{{a}_{3}}{2} ( {φ}_{4} - 2 {φ}_{3} + {φ}_{2} ) + 2 {φ}_{4} - 3 {φ}_{3} + {φ}_{2} \qquad ( 23 )$$

$${a}_{3} = \frac{4 {φ}_{4} - 9 {φ}_{3} + 6 {φ}_{2} - {μ}_{1}}{- {φ}_{4} + 3 {φ}_{3} - 3 {φ}_{2} + {μ}_{1}} \qquad ( 24 )$$

$${a}_{4} = \frac{{a}_{6} + {a}_{7}}{2} \qquad ( 25 )$$

$${a}_{5} = \frac{{a}_{6} - {a}_{7}}{2} \qquad ( 26 )$$

$${a}_{6} = \frac{{a}_{3} ( {φ}_{2} - {μ}_{1} ) + 2 {φ}_{2} - {μ}_{1}}{{a}_{2}} - 3 \qquad ( 27 )$$

$${a}_{7} = \sqrt{{( \frac{{a}_{3} ( {φ}_{2} - {μ}_{1} ) + 2 {φ}_{2} - {μ}_{1}}{{a}_{2}} - 1 )}^{2} - 4 \frac{{μ}_{1} ( {a}_{3} + 1 )}{{a}_{2}}} \qquad ( 28 )$$

$${φ}_{i} = \frac{{μ}_{i}}{{μ}_{i - 1}} , i \geq 1 \qquad ( 29 )$$

$${μ}_{1} = {\sum }_{i = 1}^{N} {μ}_{1}^{( i )} = N {μ}_{1}^{( i )} \qquad ( 30 )$$

$$\begin{matrix}{μ}_{2} = E [ {( {\sum }_{i = 1}^{N} {X}_{i} )}^{2} ] + 2 {\sum }_{i = 1}^{N - 1} {\sum }_{j = m + 1}^{M} E [ {X}_{i} ] E [ {X}_{j} ] \\ = N {μ}_{2}^{( i )} + 2 ( \begin{matrix}N \\ 2\end{matrix} ) E [ {X}_{i} ] E [ {X}_{j} ] \\ = N {μ}_{2}^{( i )} + N ( N - 1 ) {μ}_{1}^{( i )} {μ}_{1}^{( i )}\end{matrix} \qquad ( 31 )$$

where, E[·] represents expectation;

$$\{ \begin{matrix}N \geq 3 , \\ {μ}_{3} = E [ {( {\sum }_{i = 1}^{N} {X}_{i} )}^{3} ] = {\sum }_{i = 1}^{N} E [ {X}_{i}^{3} ] + 3 {\sum }_{i = 1}^{N} {{\sum }_{j = 1}^{N}}_{j \neq i} E [ {X}_{i} ] E [ {X}_{j}^{2} ] + 6 {\sum }_{i = 1}^{N - 2} {\sum }_{j = i + 1}^{N - 1} {\sum }_{k = j + 1}^{N} E [ {X}_{i} ] E [ {X}_{j} ] E [ {X}_{k} ] \\ = N {μ}_{3}^{( i )} + 3 N ( N - 1 ) {μ}_{1}^{( i )} {μ}_{2}^{( i )} + N ( N - 1 ) ( N - 2 ) {μ}_{1}^{( i )} {μ}_{1}^{( i )} {μ}_{1}^{( i )} \\ N = 2 , \\ {μ}_{3} = 2 {μ}_{3}^{( i )} + 3 \times 2 {μ}_{1}^{( i )} {μ}_{2}^{( i )} \\ N = 1 , \\ {μ}_{3} = {μ}_{3}^{( i )}\end{matrix} \qquad ( 32 )$$

$$\{ \begin{matrix}N \geq 4 , \\ {μ}_{4} = E [ {( {\sum }_{i = 1}^{N} {X}_{i} )}^{4} ] = {\sum }_{i = 1}^{N} E [ {X}_{i}^{4} ] + 6 {\sum }_{i = 1}^{N - 1} {\sum }_{j = i + 1}^{N} E [ {X}_{i}^{2} {X}_{j}^{2} ] + 4 {\sum }_{i = 1}^{N} {{\sum }_{j = 1}^{N}}_{j \neq i} E [ {X}_{i}^{3} {X}_{j} ] + 12 {\sum }_{i = 1}^{N} {{\sum }_{j = 1}^{N}}_{j \neq i} {{\sum }_{k > j}^{N}}_{k \neq i} E [ {X}_{i}^{2} {X}_{j} {X}_{k} ] + 24 {\sum }_{i < j < k < l} E [ {X}_{i} {X}_{j} {X}_{k} {X}_{l} ] \\ = N {μ}_{4}^{( i )} + 3 N ( N - 1 ) {μ}_{2}^{( i )} {μ}_{2}^{( i )} + 4 N ( N - 1 ) {μ}_{3}^{( i )} {μ}_{1}^{( i )} + 6 N ( N - 1 ) ( N - 2 ) {μ}_{2}^{( i )} {μ}_{1}^{( i )} {μ}_{1}^{( i )} + N ( N - 1 ) ( N - 2 ) ( N - 3 ) {μ}_{1}^{( i )} {μ}_{1}^{( i )} {μ}_{1}^{( i )} {μ}_{1}^{( i )} \\ N = 3 , \\ {μ}_{4} = 3 {μ}_{4}^{( i )} + 6 {\sum }_{i = 1}^{2} {\sum }_{j = i + 1}^{3} E [ {X}_{i}^{2} {X}_{j}^{2} ] + 4 {\sum }_{i = 1}^{3} {{\sum }_{j = 1}^{3}}_{j \neq i} E [ {X}_{i}^{3} {X}_{j} ] + 12 ( E [ {X}_{i}^{2} {X}_{2} {X}_{3} ] + E [ E [ {X}_{2}^{2} {X}_{1} {X}_{3} ] + E [ {X}_{3}^{2} {X}_{1} {X}_{2} ] ) \\ = 3 {μ}_{4}^{( i )} + 24 {μ}_{1}^{( i )} {μ}_{3}^{( i )} + 18 {μ}_{2}^{( i )} {μ}_{2}^{( i )} + 36 {μ}_{2}^{( i )} {μ}_{1}^{( i )} {μ}_{1}^{( i )} \\ N = 2 , \\ {μ}_{4} = 2 {μ}_{4}^{( i )} + 4 ( E [ {X}_{1} ] E [ {X}_{2}^{3} ] + E [ {X}_{2} ] E [ {X}_{1}^{3} ] ) + 6 E [ {X}_{1}^{2} ] E [ {X}_{2}^{2} ] \\ = 2 {μ}_{4}^{( i )} + 8 {μ}_{1}^{( i )} {μ}_{3}^{( i )} + 6 {μ}_{2}^{( i )} {μ}_{2}^{( i )} \\ N = 1 , \\ {μ}_{4} = {μ}_{4}^{( i )}\end{matrix} \qquad ( 33 ) ;$$

to obtain a₁, a₂, a₃, a₄, first four moments of μₗ are calculated, and μₗ⁽ⁱ⁾ (1≤l≤4) of a variable Aᵤ is first calculated:

$${μ}_{1}^{( i )} = E [ {X}_{i} ] = E [ {X}_{i 1} {X}_{i 2} ] = E [ \vert {h}_{si} \vert \vert {g}_{{id}_{k}} \vert ] = E [ \vert {h}_{si} \vert ] E [ \vert {g}_{{id}_{k}} \vert ] \qquad ( 34 )$$

$${μ}_{2}^{( i )} = E [ {X}_{i}^{2} ] = E [ {X}_{i 1}^{2} {X}_{i 2}^{2} ] = E [ {\vert {h}_{si} \vert}^{2} {\vert {g}_{{id}_{k}} \vert}^{2} ] = E [ {\vert {h}_{si} \vert}^{2} ] E [ {\vert {g}_{{id}_{k}} \vert}^{2} ] \qquad ( 35 )$$

$${μ}_{3}^{( i )} = E [ {X}_{i}^{3} ] = E [ {X}_{i 1}^{3} {X}_{i 2}^{3} ] = E [ {\vert {h}_{si} \vert}^{3} {\vert {g}_{{id}_{k}} \vert}^{3} ] = E [ {\vert {h}_{si} \vert}^{3} ] E [ {\vert {g}_{{id}_{k}} \vert}^{3} ] \qquad ( 36 )$$

$${μ}_{4}^{( i )} = E [ {X}_{i}^{4} ] = E [ {X}_{i 1}^{4} {X}_{i 2}^{4} ] = E [ {\vert {h}_{si} \vert}^{4} {\vert {g}_{{id}_{k}} \vert}^{4} ] = E [ {\vert {h}_{si} \vert}^{4} ] E [ {\vert {g}_{{id}_{k}} \vert}^{4} ] \qquad ( 37 ) .$$

In a class of this embodiment, the μₗ⁽ⁱ⁾(1≤l≤4) of a variable Aᵤ is calculated as follows:
firstly, calculating the expectations of Xᵢ₁ and Xᵢ₂, and calculating the expectation of fₓ_{ᵢ₁} (x) as follows:

$$\begin{matrix}E [ \vert {h}_{si} \vert ] = E [ \vert {g}_{{id}_{k}} \vert ] = {{\int }^{∞}}_{0} {xf}_{{X}_{i 1}} ( x ) dx \\ = {{\int }^{∞}}_{0} x \frac{2 {α}^{α} {x}^{2 α - 1}}{{R}^{2 α} Γ ( α )} exp ( \frac{- {x}^{2}}{{R}^{2}} α ) dx \\ = \frac{{{α}^{α} ( \frac{α}{{R}^{2}} )}^{- 0.5 - α} {R}^{- 2 α} Γ ( 0.5 + α )}{Γ ( α )}\end{matrix} \qquad ( 38 )$$

substituting formula (38) into formula (34), to yield:

$${μ}_{1}^{( i )} = {( \frac{{{α}^{α} ( \frac{α}{{R}^{2}} )}^{- 0.5 - α} {R}^{- 2 α} Γ ( 0.5 + α )}{Γ ( α )} )}^{2} \qquad ( 39 )$$

parsing processes of μ₂⁽ⁱ⁾, μ₃⁽ⁱ⁾, μ₄⁽ⁱ⁾ are the same as that of μₗ⁽ⁱ⁾:

$${μ}_{2}^{( i )} = {( {{α}^{α} ( \frac{α}{{R}^{2}} )}^{- α} {R}^{2 - 2 α} )}^{2} \qquad ( 40 )$$

$${μ}_{3}^{( i )} = {( \frac{{{α}^{α} ( \frac{α}{{R}^{2}} )}^{- 1.5 - α} {R}^{- 2 α} Γ ( 1.5 + α )}{Γ ( α )} )}^{2} \qquad ( 41 )$$

$${μ}_{4}^{( i )} = {( \frac{{α}^{α} ( 1 + α ) {( \frac{α}{{R}^{2}} )}^{- 2 - α} {R}^{- 2 α} Γ ( 1 + α )}{Γ ( α )} )}^{2} \qquad ( 42 )$$

to obtain the outrage probability of the legitimate NOMA user and the intercept probability when the eavesdropper intercepts the information xₙ and xₘ:

$${P}_{out , n} = {F}_{{A}_{n}} ( \sqrt{\frac{{d}_{B}^{τ} {d}_{R , n}^{τ} ( {2}^{2 {R}_{n}} - 1 )}{{ρ}_{s} ( {α}_{n} - x {ρ}_{{SD}_{n}}^{2} )}} ) = {a}_{1} {a}_{2} {G}_{2 , 3}^{2 , 1} ( \frac{\sqrt{\frac{{d}_{B}^{τ} {d}_{R , n}^{τ} ( {2}^{2 {R}_{n}} - 1 )}{{ρ}_{s} ( {α}_{n} - ( {2}^{2 {R}_{n}} - 1 ) {ρ}_{{SD}_{n}}^{2} )}}}{{a}_{2}} \vert \begin{matrix}1 ; {a}_{3} + 1 \\ {a}_{4} + 1 ; {a}_{5} + 1 ; 0\end{matrix} ) \qquad ( 43 )$$

$${P}_{out , m} = {F}_{{A}_{m}} ( \sqrt{\frac{{d}_{B}^{τ} {d}_{R , m}^{τ} x}{{ρ}_{S} ( {α}_{m} - x ( {α}_{n} + {ρ}_{{SD}_{m}}^{2} ) )}} ) = {a}_{1} {a}_{2} {G}_{2 , 3}^{2 , 1} ( \frac{\sqrt{\frac{{d}_{B}^{τ} {d}_{R , m}^{τ} ( {2}^{2 {R}_{m}} - 1 )}{{ρ}_{S} ( {α}_{m} - ( {2}^{2 {R}_{m}} - 1 ) ( {α}_{n} + {ρ}_{{SD}_{m}}^{2} ) )}}}{{a}_{2}} \vert \begin{matrix}1 ; {a}_{3} + 1 \\ {a}_{4} + 1 ; {a}_{5} + 1 ; 0\end{matrix} ) \qquad ( 44 )$$

$$\begin{matrix}{P}_{int , n} = 1 - {P}_{r} ( {C}_{{E}_{n}} \leq {R}_{n} ) \\ = 1 - {F}_{{γ}_{{E}_{n}}} ( {2}^{2 {R}_{n}} - 1 ) \\ = 1 - {F}_{{A}_{e}} ( \sqrt{\frac{{d}_{B}^{τ} {d}_{R , e}^{τ} ( {2}^{2 {R}_{n}} - 1 )}{{ρ}_{E} ( {α}_{n} - ( {2}^{2 {R}_{n}} - 1 ) {ρ}_{SE}^{2} )}} ) \\ = 1 - {a}_{1} {a}_{2} {G}_{2 , 3}^{2 , 1} ( \frac{\sqrt{\frac{{d}_{B}^{τ} {d}_{R , e}^{τ} ( {2}^{2 {R}_{n}} - 1 )}{{ρ}_{E} ( {α}_{n} - ( {2}^{2 {R}_{n}} - 1 ) {ρ}_{SE}^{2} )}}}{{a}_{2}} \vert \begin{matrix}1 ; {a}_{3} + 1 \\ {a}_{4} + 1 ; {a}_{5} + 1 ; 0\end{matrix} )\end{matrix} \qquad ( 45 )$$

$$\begin{matrix}{P}_{int , m} = 1 - {P}_{r} ( {C}_{{E}_{m}} \leq {R}_{m} ) \\ = 1 - {F}_{{γ}_{{E}_{m}}} ( {2}^{2 {R}_{m}} - 1 ) \\ = 1 - {F}_{{A}_{e}} ( \sqrt{\frac{{d}_{B}^{τ} {d}_{R , e}^{τ} ( {2}^{2 {R}_{m}} - 1 )}{{ρ}_{E} ( {α}_{m} - ( {2}^{2 {R}_{m}} - 1 ) ( {α}_{n} + {ρ}_{SE}^{2} ) )}} ) \\ = 1 - {a}_{1} {a}_{2} {G}_{2 , 3}^{2 , 1} ( \frac{\sqrt{\frac{{d}_{B}^{τ} {d}_{R , e}^{τ} ( {2}^{2 {R}_{m}} - 1 )}{{ρ}_{E} ( {α}_{m} - ( {2}^{2 {R}_{m}} - 1 ) ( {α}_{n} + {ρ}_{SE}^{2} ) )}}}{{a}_{2}} \vert \begin{matrix}1 ; {a}_{3} + 1 \\ {a}_{4} + 1 ; {a}_{5} + 1 ; 0\end{matrix} )\end{matrix} \qquad ( 46 ) ;$$

thus completing secure transmission of the physical layer of the system.

The following advantages are associated with the wireless secure communication method using reconfigurable intelligent surface-non-orthogonal multiple access (RIS-NOMA) under complex channel conditions of the disclosure:
1. Compared with traditional NOMA systems and RIS-assisted OMA systems, the method of the disclosure considers the actual complex channel environment, and the RIS assisted physical layer security performance evaluation of the NOMA systems is more in line with practical scenarios.
2. The fading channel of the disclosure is universal and can be applied to various wireless communication environments.
3. The hardware loss considered in the method is of great significance in practical communication systems.

### BRIEF DESCRIPTION OF THE DRAWINGS

FIG. 1 is a flow chart of a wireless secure communication method using reconfigurable intelligent surface-non-orthogonal multiple access (RIS-NOMA) under complex channel conditions;

FIG. 2 is a model diagram of a RIS-NOMA communication system of the disclosure;

FIG. 3 shows a variation of OP with SNR when N and Case are different;

FIG. 4 shows OP of NOMA users Dₙ and Dₘ;

FIG. 5 shows IP of NOMA users Dₙ and Dₘ;

FIG. 6 shows a variation of intercept probability with outage probability under different N;

FIG. 7 shows a variation of OP with signal-to-noise ratio at different cases and different Rₙ;

FIG. 8 shows a variation of OP with signal-to-noise ratio when different ρ and N;

FIG. 9 shows a variation of OP with signal-to-noise ratio when RHI is located at different nodes;

FIG. 10 shows a variation of IP with signal-to-noise ratio when RHI is located at different nodes;

FIG. 11 is a comparison of outrage probabilities of NOMA and OMA under different N conditions; and

FIG. 12 is a comparison of intercept probabilities of NOMA and OMA under different N conditions.

### DETAILED DESCRIPTION

To further illustrate the disclosure, embodiments detailing a wireless secure communication method using reconfigurable intelligent surface-non-orthogonal multiple access (RIS-NOMA) under complex channel conditions are described below. It should be noted that the following embodiments are intended to describe and not to limit the disclosure.

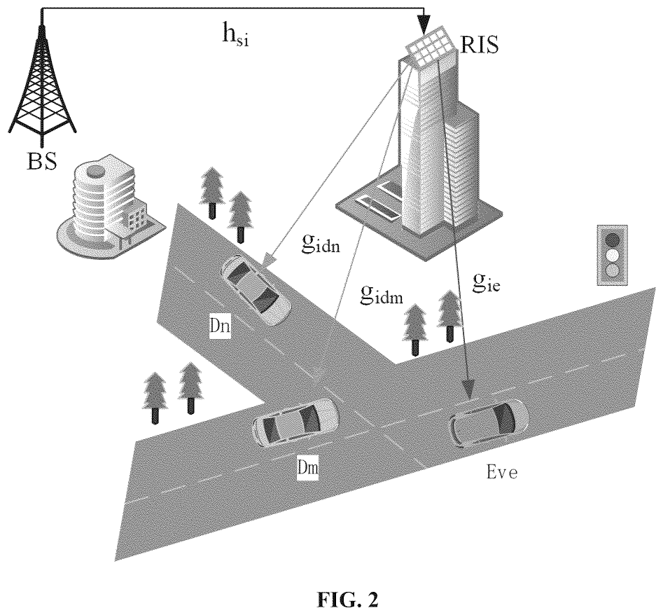

FIG. 2 is a model diagram of a RIS-NOMA communication system of the disclosure, which comprises a base station (BS), a reconfigurable intelligent surface (RIS), a legitimate NOMA user, and an eavesdropper (Eve); the legitimate NOMA user comprises a legitimate remote user Dₘ, and a legitimate near user Dₙ, and the base station communicates with the reconfigurable intelligent surface (RIS); the reconfigurable intelligent surface (RIS) communicates with the legitimate NOMA user; the eavesdropper (Eve) intercepts a signal transmitted by the RIS; an arbitrary channel link obeys k-u shadow fading; each node in the RIS-NOMA communication system encounters a residual hardware impairment (RHI).

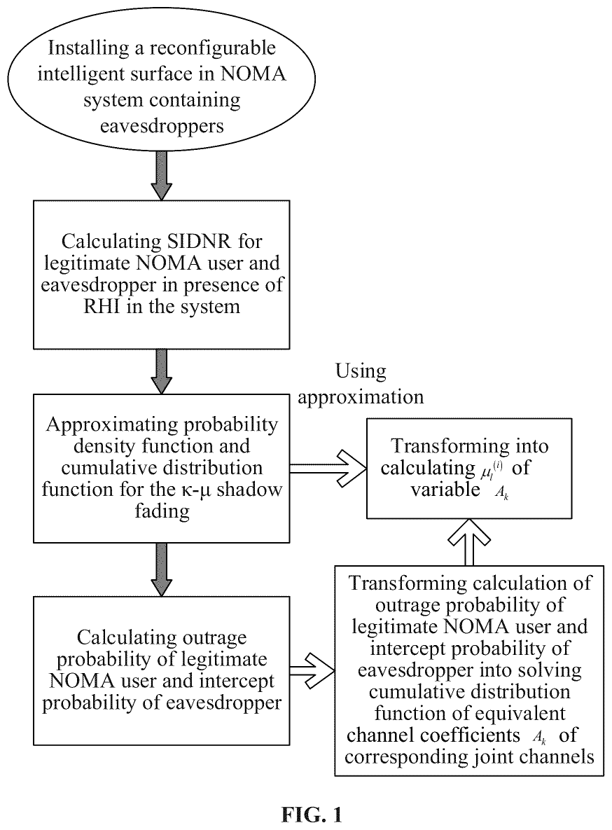

The wireless secure communication method using reconfigurable intelligent surface-non-orthogonal multiple access (RIS-NOMA) under complex channel conditions, as shown in FIG. 1, comprises:
1) calculating a signal to interference plus distortion noise ratio (SIDNR) for the legitimate NOMA user and the eavesdropper in the presence of RHI in the system, which is performed as follows:
defining a channel coefficient from the base station to an ith RIS reflecting surface in the system as hₛᵢ, and channel coefficients from the RIS to the legitimate NOMA user and to the eavesdropper as g_{id}_{ᵤ}, u∈(n,m) and gᵢₑ, respectively;
when the legitimate near user Dₙ detects a weak signal xₘ, the signal to interference plus distortion to noise ratio SIDNR is expressed as:

$${γ}_{{D}_{n} \to {D}_{m}} = \frac{{α}_{m} {A}_{n}^{2}}{{A}_{n}^{2} ( {α}_{n} + {ρ}_{{SD}_{n}}^{2} ) + \frac{{d}_{B}^{τ} {d}_{R , n}^{τ}}{{ρ}_{S}}} \qquad ( 1 ) ;$$

where, αₘ and αₙ represent power distribution coefficients of the legitimate remote user Dₘ and the legitimate near user Dₙ, respectively, and

$${α}_{n} < {α}_{m} , {α}_{m} + {α}_{n} = 1 ; {ρ}_{S} = \frac{{P}_{S}}{{σ}_{D}^{2}}$$

represents an average signal-to-noise ratio of a legal link, Ps is a transmit power of BS, and is an additive white Gaussian noise channel variance; ρ_{SD}, represents an overall RHI level of a link BS→Dₙ; Aₙ=Σᵢ₌₁^{N}|hₛᵢ∥g_{id}_{ₙ}| represents a joint channel coefficient of the link BS→Dₙ; hₛᵢ is a channel coefficient of a link BS→RIS; g_{id}_{ₙ} is a channel coefficient of a link RIS→Dₙ; |·| represents modeling; d_{B} and d_{R,n} represent a distance from the base station to the RIS and a distance from the RIS to the legitimate near user Dₙ, respectively; and τ represents a path fading index;
through SIC technology, the SIDNR of Dₙ decoding its own signal is given by the following equation:

$${γ}_{{D}_{n}} = \frac{{α}_{n} {A}_{n}^{2}}{{A}_{n}^{2} {ρ}_{{SD}_{n}}^{2} + \frac{{d}_{B}^{τ} {d}_{R , n}^{τ}}{{ρ}_{S}}} \qquad ( 2 ) ;$$

when Dₘ decodes its own signal, a signal xₙ with strong channel gain is considered as noise, and SIDNR is represented as follows:

$${γ}_{{D}_{m}} = \frac{{α}_{m} {A}_{m}^{2}}{{A}_{m}^{2} ( {α}_{n} + {ρ}_{{SD}_{m}}^{2} ) + \frac{{d}_{B}^{τ} {d}_{R , m}^{τ}}{{ρ}_{S}}} \qquad ( 3 ) ;$$

where Aₘ=Σᵢ₌₁^{N}|hₛᵢ∥g_{id}_{ₘ}|; g_{id}_{ₘ} is a channel coefficient of a link RIS→Dₘ;
when the eavesdropper intercepts the signals xₙ and xₘ respectively, the obtained SIDNR is expressed as follows:

$${γ}_{{E}_{n}} = \frac{{α}_{n} {A}_{n}^{2}}{{A}_{e}^{2} {ρ}_{SE}^{2} + \frac{{d}_{B}^{τ} {d}_{R , e}^{τ}}{{ρ}_{E}}} \qquad ( 4 )$$

$${γ}_{{E}_{m}} = \frac{{α}_{m} {A}_{e}^{2}}{{A}_{e}^{2} ( {α}_{n} + {ρ}_{SE}^{2} ) + \frac{{d}_{B}^{τ} {d}_{R , e}^{τ}}{{ρ}_{E}}} \qquad ( 5 )$$

$${ρ}_{E} = \frac{{P}_{S}}{{σ}_{E}^{2}}$$

represents SNR of an eavesdropping link; Aₑ=Σᵢ₌₁^{N}|hₛᵢ∥gᵢₑ|; gᵢₑ represents a joint channel coefficient of a link RIS→Eve; σ_{E}² represents an additive white Gaussian noise channel variance of the eavesdropper; ρ_{SE} represents an overall RHI level of a link BS→Eve; and d_{R,e} represents a distance from the RIS to the eavesdropper;
2) approximating a probability density function and cumulative distribution function for the κ-μ shadow fading, which is performed as follows:
SIDNR of the legitimate NOMA user and the eavesdropper contains Aᵤ=Σᵢ₌₁^{N}|hₛᵢ∥g_{id}_{ᵤ}|, u∈(n,m) and Aₑ=Σᵢ₌₁^{N}|hₛᵢ∥gᵢₑ| as equivalent channel coefficients i=1 i=1 for corresponding joint channels;
assuming that envelopes |hₛᵢ|, |g_{id}_{ᵤ}|, u∈(n,m) and |gᵢₑ| of all instantaneous channel coefficients are subject to independent and identically distributed k-u shadow fading, and X represents the envelopes |hₛᵢ|, |g_{id}_{ᵤ}|, u∈(n,m) and |gᵢₑ| of instantaneous channel coefficients, the cumulative distribution functions and probability density functions thereof are represented as follows:

$${F}_{X} ( x ) = \frac{{μ}^{μ - 1} {{m}^{m} ( 1 + k )}^{μ}}{Γ ( μ ) {( μ k + m )}^{m}} {( \frac{1}{R} )}^{2 μ} {x}^{2 μ} {Φ}_{2} ( μ - m , m , μ + 1 ; - \frac{μ ( 1 + k ) {x}^{2}}{{R}^{2}} , - \frac{μ ( 1 + k )}{{R}^{2}} \frac{{mx}^{2}}{μ k + m} ) \qquad ( 6 )$$

$$\begin{matrix}{f}_{X} ( x ) = \frac{2 {μ}^{μ} {{m}^{m} ( 1 + k )}^{μ}}{Γ ( μ ) {( μ k + m )}^{m}} ( \frac{1}{{R}^{2 μ}} ) {x}^{2 μ - 1} exp ( - \frac{μ ( 1 + k )}{{R}^{2}} {x}^{2} ) {}_{1} {F}_{1} ( m , μ ; \frac{{μ}^{2} k ( 1 + k )}{( μ k + m ) {R}^{2}} {x}^{2} ) \\ = \frac{2 {α}^{μ}}{Γ ( μ ) {b}^{m}} {x}^{2 , μ - 1} exp ( - α x ) {}_{1} {F}_{1} ( m , μ ; \frac{{μ}^{2} k ( 1 + k )}{( μ k + m ) {R}^{2}} {x}^{2} )\end{matrix} \qquad ( 7 )$$

Γ(·), Φ₂(·) and ₁F₁(·) are defined as a Gamma function, binary confluence hypergeometric function, and confluence hypergeometric function, respectively;

$$a = \frac{μ ( 1 + k )}{Ω} , b = \frac{μ k + m}{m} ;$$

k is a ratio of a total power of dispersed components to dominant sight components, μ is a total number of multipath clusters, m is a fading degree parameter, and R is an average power of the channel;

to simplify calculation, the cumulative distribution function and probability density function of the k-μ shadow distribution are approximated as follows:

$${F}_{X} ( x ) \approx \frac{{α}^{α} {x}^{2 α}}{Γ ( α + 1 ) {R}^{2 a}} {}_{1} {F}_{1} ( α , α + 1 , \frac{- {x}^{2} α}{{R}^{2}} ) \qquad ( 8 )$$

$${f}_{X} ( x ) \approx \frac{2 {α}^{α} {x}^{2 α - 1}}{{R}^{2 α} Γ ( α )} exp ( \frac{- {x}^{2}}{{R}^{2}} α ) ; and \qquad ( 9 )$$

$$α = \frac{m {μ ( 1 + k )}^{2}}{m + μ {k}^{2} + 2 m k} ;$$

3) calculating an outrage probability of the legitimate NOMA user and an intercept probability of the eavesdropper, which is performed as follows:
outage probability:
when a channel capacity of a main channel is less than a set threshold Rᵤ, and u∈(n,m), an interrupt event occurs; Cᵤ=½log₂(1+γ_{D}_{ᵤ}) represents the channel capacity of the main channel, and the outrage probability of a legitimate NOMA user Dᵤ is expressed as follows:

$$\begin{matrix}{P}_{out , n} = Pr \{ {C}_{U} \leq {R}_{U} \} \\ = Pr \{ {γ}_{{D}_{u}} \leq {2}^{2 {R}_{u}} - 1 \} \\ = {F}_{{γ}_{{D}_{u}}} ( {2}^{2 {R}_{u}} - 1 )\end{matrix} \qquad ( 10 )$$

3.1) the outrage probability of the legitimate near user Dₙ:

$$\begin{matrix}{P}_{out , n} = Pr \{ {C}_{n} \leq {R}_{n} \} \\ = {F}_{{γ}_{{D}_{n}}} ( {2}^{2 {R}_{n}} - 1 ) ;\end{matrix} \qquad ( 11 )$$

F_{γD}_{ₙ}(x) is expressed as:

$$\begin{matrix}{F}_{{γ}_{{D}_{n}}} ( x ) = Pr \{ {γ}_{{D}_{n}} \leq x \} \\ = Pr \{ \frac{{α}_{n} {A}_{n}^{2}}{{A}_{n}^{2} {ρ}_{{SD}_{n}}^{2} + \frac{{d}_{B}^{τ} {d}_{R , n}^{τ}}{{ρ}_{S}}} \leq x \} \\ = Pr \{ {A}_{n}^{2} \leq \frac{{d}_{B}^{τ} {d}_{R , n}^{τ} x}{{ρ}_{S} ( {α}_{n} - x {ρ}_{{SD}_{n}}^{2} )} \} \\ = {F}_{{A}_{n}} ( \sqrt{\frac{{d}_{B}^{τ} {d}_{R , n}^{τ} x}{{ρ}_{S} ( {α}_{n} - x {ρ}_{{SD}_{n}}^{2} )}} ) ;\end{matrix} \qquad ( 12 )$$

F_{A}_{ₙ}(x) represents a cumulative distribution function of Aₙ;
3.2) the outrage probability of the legitimate remote user Dₘ:

$$\begin{matrix}{P}_{out , m} = Pr \{ {C}_{m} \leq {R}_{m} \} \\ = {F}_{{γ}_{{D}_{m}}} ( {2}^{2 {R}_{m}} - 1 )\end{matrix} \qquad ( 13 )$$

F_{γD}_{ₘ}(x) is expressed as:

$$\begin{matrix}{F}_{{γ}_{{D}_{m}}} ( x ) = Pr \{ {γ}_{{D}_{m}} \leq x \} \\ = Pr \{ \frac{{α}_{m} {A}_{m}^{2}}{{A}_{m}^{2} {ρ}_{{SD}_{m}}^{2} + \frac{{d}_{B}^{τ} {d}_{R , m}^{τ}}{{ρ}_{S}}} \leq x \} \\ = Pr \{ {A}_{m}^{2} \leq \frac{{d}_{B}^{τ} {d}_{R , m}^{τ} x}{{ρ}_{S} ( {α}_{m} - x ( {α}_{n} + {ρ}_{{SD}_{m}}^{2} ) )} \} \\ = {F}_{{A}_{m}} ( \sqrt{\frac{{d}_{B}^{τ} {d}_{R , m}^{τ} x}{{ρ}_{S} ( {α}_{n} - x ( {α}_{n} + {ρ}_{{SD}_{m}}^{2} ) )}} )\end{matrix} \qquad ( 14 )$$

F_{A}_{ₘ}(x) represents a cumulative distribution function of Aₘ;
the intercept probability of the eavesdropper is calculated as follows:
when a channel capacity of an eavesdropping channel is greater than a transmission rate, an interception event occurs; C_{E}_{ᵤ}=½log₂(1+γ_{DE}_{ᵤ}) represents the channel capacity of the eavesdropping channel, and the intercept probability that the eavesdropper intercepts a legitimate user's information is denoted as follows:

$$\begin{matrix}{P}_{int , n} = {P}_{r} ( {C}_{{E}_{u}} > {R}_{u} ) \\ = 1 - {P}_{r} ( {C}_{{E}_{u}} \leq {R}_{u} ) \\ = 1 - {P}_{r} ( {γ}_{{E}_{u}} \leq {2}^{2 {R}_{u}} - 1 ) \\ = 1 - {F}_{{γ}_{{E}_{u}}} ( {2}^{2 {R}_{u}} - 1 ) ;\end{matrix} \qquad ( 15 )$$

3.3) the intercept probability when the eavesdropper intercepts the legitimate near user Dₙ:

$$\begin{matrix}{P}_{int , n} = {P}_{r} ( {C}_{{E}_{n}} > {R}_{n} ) \\ = 1 - {P}_{r} ( {C}_{{E}_{n}} \leq {R}_{n} ) \\ = 1 - {F}_{{γ}_{{E}_{n}}} ( {2}^{2 {R}_{n}} - 1 ) ;\end{matrix} \qquad ( 16 )$$

F_{γE}_{ₙ}(x) is expressed as:

$$\begin{matrix}{F}_{{γ}_{{E}_{n}}} ( x ) = Pr \{ {γ}_{{E}_{n}} \leq x \} \\ = Pr \{ \frac{{α}_{n} {A}_{e}^{2}}{{A}_{e}^{2} {ρ}_{SE}^{2} + \frac{{d}_{B}^{τ} {d}_{R , e}^{τ}}{{ρ}_{E}}} \leq x \} \\ = Pr \{ {A}_{e}^{2} \leq \frac{{d}_{B}^{τ} {d}_{R , e}^{τ} x}{{ρ}_{E} ( {α}_{n} - x {ρ}_{SE}^{2} )} \} \\ = {F}_{{A}_{e}} ( \sqrt{\frac{{d}_{B}^{τ} {d}_{R , e}^{τ} x}{{ρ}_{E} ( {α}_{n} - x {ρ}_{SE}^{2} )}} )\end{matrix} \qquad ( 17 )$$

F_{A}_{ₑ}(x) represents a cumulative distribution function of Aₑ;
3.4) the intercept probability when the eavesdropper intercepts the legitimate remote user Dₘ:

$$\begin{matrix}{P}_{int , m} = {P}_{r} ( {C}_{{E}_{m}} > {R}_{m} ) \\ = 1 - {P}_{r} ( {C}_{{E}_{m}} \leq {R}_{m} ) \\ = 1 - {F}_{{γ}_{{E}_{m}}} ( {2}^{2 {R}_{m}} - 1 )\end{matrix} \qquad ( 18 )$$

F_{γE}_{ₘ}(x) is expressed as:

$$\begin{matrix}{F}_{{γ}_{{E}_{m}}} ( x ) = Pr \{ {γ}_{{E}_{m}} \leq x \} \\ = Pr \{ \frac{{α}_{m} {A}_{e}^{2}}{{A}_{e}^{2} ( {α}_{n} + {ρ}_{SE}^{2} ) + \frac{{d}_{B}^{τ} {d}_{R , e}^{τ}}{{ρ}_{E}}} \leq x \} \\ = Pr \{ {A}_{e}^{2} \leq \frac{{d}_{B}^{τ} {d}_{R , e}^{τ} x}{{ρ}_{E} ( {α}_{m} - x ( {α}_{n} + {ρ}_{SE}^{2} ) )} \} \\ = {F}_{{A}_{e}} ( \sqrt{\frac{{d}_{B}^{τ} {d}_{R , e}^{τ} x}{{ρ}_{E} ( {α}_{m} - x ( {α}_{n} + {ρ}_{SE}^{2} ) )}} )\end{matrix} \qquad ( 19 )$$

F_{A}_{ₑ}(x) represents a cumulative distribution function of Aₑ;
4) transforming the calculation of the outrage probability of the legitimate NOMA user and the intercept probability of the eavesdropper into solving a cumulative distribution function of equivalent channel coefficients of corresponding joint channels, whereby measuring physical layer secure transmission performance of the system, which is performed as follows:
given Aᵤ=Σᵢ₌₁^{N}|hₛᵢ∥g_{id}_{ᵤ}|, let Xᵢ=Xᵢ₁Xᵢ₂=|hₛᵢ∥g_{id}_{ᵤ}|, and Aᵤ=Σᵢ₌₁^{N}Xᵢ, approximating PDF and CDF of Aᵤ as follows:

$${f}_{{A}_{u}} ( x ) = {a}_{1} {G}_{1 , 2}^{2 , 0} ( \frac{x}{{a}_{2}} \vert \begin{matrix}- ; {a}_{3} \\ {a}_{4} ; {a}_{5}\end{matrix} ) \qquad ( 20 )$$

$${F}_{{A}_{u}} ( x ) \approx {a}_{1} {a}_{2} {G}_{2 , 3}^{2 , 1} ( \frac{x}{{a}_{2}} \vert \begin{matrix}1 ; {a}_{3} + 1 \\ {a}_{4} + 1 ; {a}_{5} + 1 ; 0\end{matrix} ) , x \geq 0 \qquad ( 21 )$$

$${a}_{1} = \frac{Γ ( {a}_{3} + 1 )}{{a}_{2} Γ ( {a}_{4} + 1 ) Γ ( {a}_{5} + 1 )} \qquad ( 22 )$$

$${a}_{2} \frac{- {a}_{3}}{2} ( {φ}_{4} - 2 {φ}_{3} + {φ}_{2} ) + 2 {φ}_{4} - 3 {φ}_{3} + {φ}_{2} \qquad ( 23 )$$

$${a}_{3} = \frac{4 {φ}_{4} - 9 {φ}_{3} + 6 {φ}_{2} - {μ}_{1}}{- {φ}_{4} + 3 {φ}_{3} - 3 {φ}_{2} + {μ}_{1}} \qquad ( 24 )$$

$${a}_{4} = \frac{{a}_{6} + {a}_{7}}{2} \qquad ( 25 )$$

$${a}_{5} = \frac{{a}_{6} - {a}_{7}}{2} \qquad ( 26 )$$

$${a}_{6} = \frac{{a}_{3} ( {φ}_{2} - {μ}_{1} ) + 2 {φ}_{2} - {μ}_{1}}{{a}_{2}} - 3 \qquad ( 27 )$$

$${a}_{7} = \sqrt{{( \frac{{a}_{3} ( {φ}_{2} - {μ}_{1} ) + 2 {φ}_{2} - {μ}_{1}}{{a}_{2}} - 1 )}^{2} - 4 \frac{{μ}_{1} ( {a}_{3} + 1 )}{{a}_{2}}} \qquad ( 28 )$$

$${φ}_{i} = \frac{{μ}_{i}}{{μ}_{i - 1}} , i \geq 1 \qquad ( 29 )$$

$${μ}_{1} = {\sum }_{i = 1}^{N} {μ}_{1}^{( i )} = N {μ}_{1}^{( i )} \qquad ( 30 )$$

$$\begin{matrix}{μ}_{2} = E [ {( {\sum }_{i = 1}^{N} {X}_{i} )}^{2} ] + 2 {\sum }_{i = 1}^{N - 1} {\sum }_{j = m + 1}^{M} E [ {X}_{i} ] E [ {X}_{j} ] \\ = N {μ}_{2}^{( i )} + 2 ( \begin{matrix}N \\ 2\end{matrix} ) E [ {X}_{i} ] E [ {X}_{j} ] \\ = N {μ}_{2}^{( i )} + N ( N - 1 ) {μ}_{1}^{( i )} {μ}_{1}^{( i )}\end{matrix} \qquad ( 31 )$$

where, E[·] represents expectation;

$$\{ \begin{matrix}N \geq 3 , \\ \begin{matrix}{μ}_{3} = E [ {( {\sum }_{i = 1}^{N} {X}_{i} )}^{3} ] = {\sum }_{i = 1}^{N} E [ {X}_{i}^{3} ] + 3 {\sum }_{i = 1}^{N} {\sum }_{\begin{matrix}j = i \\ j \neq i\end{matrix}}^{N - 1} E [ {X}_{i} ] E [ {X}_{j}^{2} ] + \\ 6 {\sum }_{i = 1}^{N - 2} {\sum }_{j = i + 1}^{N - 1} {\sum }_{k = j + 1}^{N} E [ {X}_{i} ] E [ {X}_{j} ] E [ {X}_{k} ] = N {μ}_{3}^{( i )} + \\ 3 N ( N - 1 ) {μ}_{1}^{( i )} {μ}_{2}^{( i )} + N ( N - 1 ) ( N - 2 ) {μ}_{1}^{( i )} {μ}_{1}^{( i )} {μ}_{1}^{( i )}\end{matrix} \\ N = 2 , \\ {μ}_{3} = 2 {μ}_{3}^{( i )} + 3 \times 2 {μ}_{1}^{( i )} {μ}_{2}^{( i )} \\ N = 1 , \\ {μ}_{3} = {μ}_{3}^{( i )}\end{matrix} \qquad ( 32 )$$

$$\{ \begin{matrix}N \geq 4 , \\ \begin{matrix}{μ}_{4} = E [ {( {\sum }_{i = 1}^{N} {X}_{i} )}^{4} ] = {\sum }_{i = 1}^{N} E [ {X}_{i}^{4} ] + 6 {\sum }_{i = 1}^{N - 1} {\sum }_{j = i + 1}^{N} E [ {X}_{i}^{2} {X}_{j}^{2} ] + \\ 4 {\sum }_{i = 1}^{N} {\sum }_{\begin{matrix}j = 1 \\ j \neq i\end{matrix}}^{N} E [ {X}_{i}^{3} {X}_{j} ] + 12 {\sum }_{i = 1}^{N} {\sum }_{\begin{matrix}j = 1 \\ j \neq i\end{matrix}}^{N} {\sum }_{\begin{matrix}k > j \\ k \neq i\end{matrix}}^{N} E [ {X}_{i}^{2} {X}_{j} {X}_{k} ] + \\ 24 {\sum }_{i < j < k < l} E [ {X}_{i} {X}_{j} {X}_{k} {X}_{l} ] = \\ N {μ}_{4}^{( i )} + 3 N ( N - 1 ) {μ}_{2}^{( i )} {μ}_{2}^{( i )} + 4 N ( N - 1 ) {μ}_{3}^{( i )} {μ}_{1}^{( i )} + \\ 6 N ( N - 1 ) ( N - 2 ) {μ}_{2}^{( i )} {μ}_{1}^{( i )} {μ}_{1}^{( i )} + \\ N ( N - 1 ) ( N - 2 ) ( N - 3 ) {μ}_{1}^{( i )} {μ}_{1}^{( i )} {μ}_{1}^{( i )} {μ}_{1}^{( i )}\end{matrix} \\ N = 3 , \\ \begin{matrix}{μ}_{4} = 3 {μ}_{4}^{( i )} + 6 {\sum }_{i = 1}^{2} {\sum }_{j = i + 1}^{3} E [ {X}_{i}^{2} {X}_{j}^{2} ] + 4 {\sum }_{i = 1}^{3} {\sum }_{j = 1}^{3} E [ {X}_{i}^{3} {X}_{j} ] + \\ 12 ( E [ {X}_{1}^{2} {X}_{2} {X}_{3} ] + E [ {X}_{2}^{2} {X}_{1} {X}_{3} ] + E [ {X}_{3}^{2} {X}_{1} {X}_{2} ] ) = \\ 3 {μ}_{4}^{( i )} + 24 {μ}_{1}^{( i )} {μ}_{3}^{( i )} + 18 {μ}_{2}^{( i )} {μ}_{2}^{( i )} + 36 {μ}_{2}^{( i )} {μ}_{1}^{( i )} {μ}_{1}^{( i )}\end{matrix} \\ N = 2 , \\ \begin{matrix}{μ}_{4} = 2 {μ}_{4}^{( i )} + 4 ( E [ {X}_{1} ] E [ {X}_{2}^{3} ] + E [ {X}_{2} ] E [ {X}_{1}^{3} ] ) + \\ 6 E [ {X}_{1}^{2} ] E [ {X}_{2}^{2} ] = 2 {μ}_{4}^{( i )} + 8 {μ}_{1}^{( i )} {μ}_{3}^{( i )} + 6 {μ}_{2}^{( i )} {μ}_{2}^{( i )}\end{matrix} \\ N = 1 , \\ {μ}_{4} = {μ}_{4}^{( i )}\end{matrix} ; \qquad ( 33 )$$

to obtain a₁, a₂, a₃, a₄, first four moments of μₗ are calculated, and μₗ⁽ⁱ⁾ (1≤l≤4) of a variable Aᵤ is first calculated:

$${μ}_{1}^{( i )} = E [ {X}_{i} ] = E [ {X}_{i 1} {X}_{i 2} ] = E [ \vert {h}_{s i} \vert \vert {g}_{{id}_{k}} \vert ] = E [ \vert {h}_{si} \vert ] E [ \vert {g}_{i {d}_{k}} \vert ] \qquad ( 34 )$$

$${μ}_{2}^{( i )} = E [ {X}_{i}^{2} ] = E [ {X}_{i 1}^{2} {X}_{i 2}^{2} ] = E [ {\vert {h}_{s i} \vert}^{2} {\vert {g}_{{id}_{k}} \vert}^{2} ] = E [ {\vert {h}_{s i} \vert}^{2} ] E [ {\vert {g}_{{id}_{k}} \vert}^{2} ] \qquad ( 35 )$$

$${μ}_{3}^{( i )} = E [ {X}_{i}^{3} ] = E [ {X}_{i 1}^{3} {X}_{i 2}^{3} ] = E [ {\vert {h}_{s i} \vert}^{3} {\vert {g}_{{id}_{k}} \vert}^{3} ] = E [ {\vert {h}_{s i} \vert}^{3} ] E [ {\vert {g}_{{id}_{k}} \vert}^{3} ] \qquad ( 36 )$$

$${μ}_{4}^{( i )} = E [ {X}_{i}^{4} ] = E [ {X}_{i 1}^{4} {X}_{i 2}^{4} ] = E [ {\vert {h}_{s i} \vert}^{4} {\vert {g}_{{id}_{k}} \vert}^{4} ] = E [ {\vert {h}_{s i} \vert}^{4} ] E [ {\vert {g}_{{id}_{k}} \vert}^{4} ] \qquad ( 37 )$$

the ρₗ⁽ⁱ⁾ (1≤l≤4) of a variable Aᵤ is calculated as follows:
firstly, calculating the expectations of Xᵢ₁ and Xᵢ₂, and calculating the expectation of f_{X}_{ᵢ₁}(x) as follows:

$$\begin{matrix}E [ \vert {h}_{si} \vert ] = E [ \vert {g}_{{id}_{k}} \vert ] \\ = {\int }_{0}^{∞} {xf}_{{X}_{i 1}} ( x ) dx \\ = {\int }_{0}^{∞} x \frac{2 {α}^{α} {x}^{2 α - 1}}{{R}^{2 α} Γ ( α )} exp ( \frac{- {x}^{2}}{{R}^{2}} α ) dx \\ = \frac{{{α}^{α} ( \frac{α}{{R}^{2}} )}^{- 0.5 - α} {R}^{- 2 α} Γ ( 0.5 + α )}{Γ ( α )}\end{matrix} \qquad ( 38 )$$

substituting formula (38) into formula (34), to yield:

$${μ}_{1}^{( i )} = {( \frac{{{α}^{α} ( \frac{α}{{R}^{2}} )}^{- 0.5 - α} {R}^{- 2 α} Γ ( 0.5 + α )}{Γ ( α )} )}^{2} \qquad ( 39 )$$

parsing processes of μ₂⁽ⁱ⁾, μ₃⁽ⁱ⁾, μ₄⁽ⁱ⁾ are the same as that of μₗ⁽ⁱ⁾.

$${μ}_{2}^{( i )} = {( {{α}^{α} ( \frac{α}{{R}^{2}} )}^{- α} {R}^{2 - 2 α} )}^{2} \qquad ( 40 )$$

$${μ}_{3}^{( i )} = {( \frac{{{α}^{α} ( \frac{α}{{R}^{2}} )}^{- 1.5 - α} {R}^{- 2 α} Γ ( 1.5 + α )}{Γ ( α )} )}^{2} \qquad ( 41 )$$

$${μ}_{4}^{( i )} = {( \frac{{α}^{α} ( 1 + α ) {( \frac{α}{{R}^{2}} )}^{- 2 - α} {R}^{- 2 α} Γ ( 1 + α )}{Γ ( α )} )}^{2} \qquad ( 42 )$$

to obtain the outrage probability of the legitimate NOMA user and the intercept probability when the eavesdropper intercepts the information xₙ and xₘ:

$$\begin{matrix}{P}_{out , n} = {F}_{{A}_{n}} ( \sqrt{\frac{{d}_{B}^{τ} {d}_{R , n}^{τ} ( {2}^{2 {R}_{n}} - 1 )}{{ρ}_{S} ( {α}_{n} - x {ρ}_{{SD}_{n}}^{2} )}} ) \\ = {a}_{1} {a}_{2} {G}_{2 , 3}^{2 , 1} ( \frac{\sqrt{\frac{{d}_{B}^{τ} {d}_{R , n}^{τ} ( {2}^{2 {R}_{n}} - 1 )}{{ρ}_{S} ( {α}_{n} - ( {2}^{2 {R}_{n}} - 1 ) {ρ}_{{SD}_{n}}^{2} )}}}{{a}_{2}} {\vert}_{{a}_{4} + 1 ; {a}_{5} + 1 ; 0}^{1 ; {a}_{3} + 1} )\end{matrix} \qquad ( 43 )$$

$$\begin{matrix}{P}_{out , m} = {F}_{{A}_{m}} ( \sqrt{\frac{{d}_{B}^{τ} {d}_{R , m}^{τ} x}{{ρ}_{S} ( {α}_{m} - x ( {α}_{n} + {ρ}_{{SD}_{m}}^{2} ) )}} ) \\ = {a}_{1} {a}_{2} {G}_{2 , 3}^{2 , 1} ( \frac{\sqrt{\frac{{d}_{B}^{τ} {d}_{R , m}^{τ} ( {2}^{2 {R}_{m}} - 1 )}{{ρ}_{S} ( {α}_{m} - ( {2}^{2 {R}_{m}} - 1 ) ( {α}_{n} + {ρ}_{{SD}_{m}}^{2} ) )}}}{{a}_{2}} {\vert}_{{a}_{4} + 1 ; {a}_{5} + 1 ; 0}^{1 ; {a}_{3} + 1} )\end{matrix} \qquad ( 44 )$$

$$\begin{matrix}{P}_{int , n} = 1 - {P}_{r} ( {C}_{{E}_{n}} \leq {R}_{n} ) \\ = 1 - {F}_{{γ}_{{E}_{n}}} ( {2}^{2 {R}_{n}} - 1 ) \\ = 1 - {F}_{{A}_{e}} ( \sqrt{\frac{{d}_{B}^{τ} {d}_{R , e}^{τ} ( {2}^{2 {R}_{n}} - 1 )}{{ρ}_{E} ( {α}_{n} - ( {2}^{2 {R}_{n}} - 1 ) {ρ}_{SE}^{2} )}} ) \\ = 1 - {a}_{1} {a}_{2} {G}_{2 , 3}^{2 , 1} ( \frac{\sqrt{\frac{{d}_{B}^{τ} {d}_{R , e}^{τ} ( {2}^{2 {R}_{n}} - 1 )}{{ρ}_{E} ( {α}_{n} - ( {2}^{2 {R}_{n}} - 1 ) {ρ}_{SE}^{2} )}}}{{a}_{2}} {\vert}_{{a}_{4} + 1 ; {a}_{5} + 1 ; 0}^{1 ; {a}_{3} + 1} )\end{matrix} \qquad ( 45 )$$

$$\begin{matrix}{P}_{int , m} = 1 - {P}_{r} ( {C}_{{E}_{m}} \leq {R}_{m} ) \\ = 1 - {F}_{{γ}_{{E}_{m}}} ( {2}^{2 {R}_{m}} - 1 ) \\ = 1 - {F}_{{A}_{e}} ( \sqrt{\frac{{d}_{B}^{τ} {d}_{R , e}^{τ} ( {2}^{2 {R}_{m}} - 1 )}{{ρ}_{E} ( {α}_{m} - ( {2}^{2 {R}_{m}} - 1 ) ( {α}_{n} + {ρ}_{SE}^{2} ) )}} ) \\ = 1 - {a}_{1} {a}_{2} {G}_{2 , 3}^{2 , 1} ( \frac{\sqrt{\frac{{d}_{B}^{τ} {d}_{R , e}^{τ} ( {2}^{2 {R}_{m}} - 1 )}{{ρ}_{E} ( {α}_{m} - ( {2}^{2 {R}_{m}} - 1 ) ( {α}_{n} + {ρ}_{SE}^{2} ) )}}}{{a}_{2}} {\vert}_{{a}_{4} + 1 ; {a}_{5} + 1 ; 0}^{1 ; {a}_{3} + 1} )\end{matrix} ; \qquad ( 46 )$$

thus completing secure transmission of the physical layer of the system.

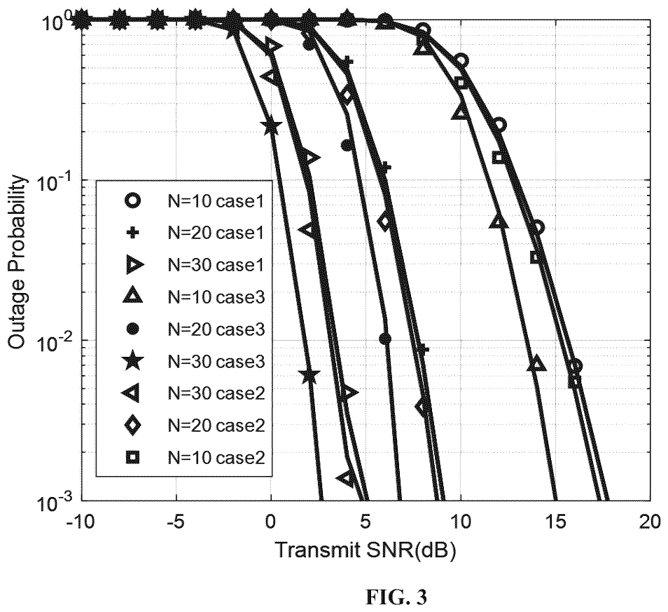

FIG. 3 shows a variation of outrage probability (OP) of a legitimate near user Dₙ under different RIS reflection unit numbers N.

To observe and understand the impact of the parameter k-u, the user's outage probability under different Cases is simulated. Case1, Case2 and Case3 are corresponding Rayleigh fading, Rice shadow fading, and k-μ shadow fading when the parameter k-μ takes special values, respectively. The Monte Carlo curves match well with the mathematically derived analytical result curves in the whole range of signal-to-noise ratio, which verifies the correctness of the theoretical analysis. In addition, under the same Case, the outage probability decreases with the increase of the number of the smart reflective surface elements N, which indicates that increasing the number of the smart reflective surface elements can reduce the outage probability of the system; the outage probability of Case3 is lower than that of Case1 and Case2 under the same N, which suggests that the general k-μ shadow fading can effectively improve the reliability of the system.

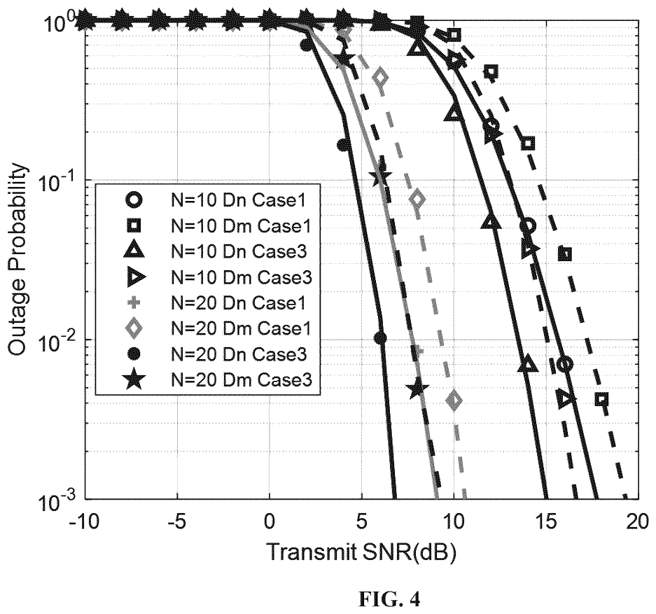

To study the interruption performance of NOMA users, FIG. 4 shows a change trend of outrage probability of near users Dₙ and remote users Dₘ with different Vs transmit powers and different number N of RIS reflection units. Firstly, it can be seen that the analysis result of the outrage probability is matched with the simulation, which indicates the correctness of the derivation of the formula for the outrage probability; secondly, the user SINR increases with the increase of the transmit power, and the outrage probability of all the users decreases with the increase of the Vs transmit power; in addition, the outrage probability of the near user is always lower than that of the remote user under different N and different cases, which means the former is more reliable. Particularly, it can also be observed that under the same Case, the user's outrage probability significantly decreases as N increases, which indicates that increasing the number of reflection units of the smart reflective surface can effectively improve the reliability of the system. Meanwhile, the outrage probability of Case3 is lower than the outrage probability of Case1 when Nis constant, which indicates that general k-μ shadow fading can effectively reduce the outrage probability of the system compared to Rayleigh fading.

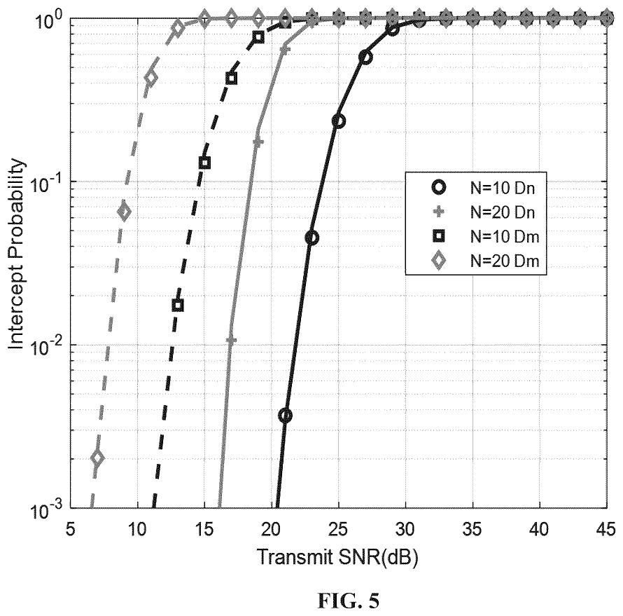

FIG. 5 shows a change trend of interrupt probability of near users Dₙ and remote users Dₘ with different Vs transmit powers and different number N of RIS reflection units. The analysis result of the interrupt probability is matched with the simulation, which indicates the correctness of the derivation of the formula for the interrupt probability. The intercept probability of all users increases with the increase of Vs transmitting power, and when N is constant, the intercept probability of the near user is always lower than that of the remote user, and the security is stronger. As N increases, the intercept probability also increases and the system security performance decreases. This indicates that the increase of the number of different RIS reflection units will decrease the outrage probability, increase the security, increase the interrupt probability, and decrease the reliability of the system. At this point, there is a trade-off between the security and reliability of the system.

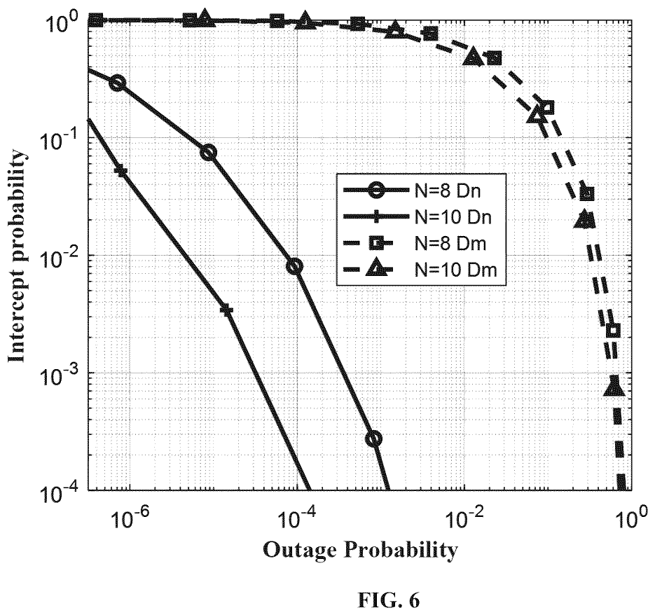

To further investigate the relationship between the outrage probability and the intercept probability of the system, FIG. 6 shows the effect of outrage probability on the intercept probability at different numbers N of the RIS reflection units. The results show that as the outrage probability gradually increases, the intercept probability decreases and vice versa, which implies that there is a trade-off between the outrage probability and the intercept probability, and between the security and reliability of the system. As the number N increases, the compromise between the security and reliability decreases. Because NOMA users adopt SIC technology, the impact of the number N on SINR of Dₙ is greater and the change of Dₙ is more significant. By increasing the number of the reflective units of RIS, the trade-off between the system security and reliability can be improved. Specifically, it can be observed that when the outrage probability is the same, the intercept probability of Dₙ is less than that of Dₘ; when the intercept probability is the same, the outrage probability of Dₙ is less than that of Dₘ, which means Dₙ has higher safety and reliability performance, and the advantage becomes more obvious with the increase of N.

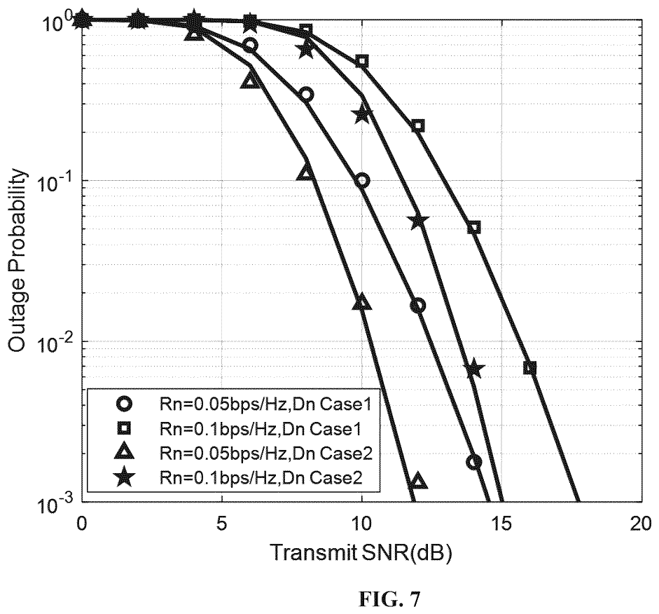

FIG. 7 shows the effect of Rₙ of different Case on the outage probability of users. The results show that the target data rate affects the system security performance. At the same Case, the system outage probability decreases as Rₙ decreases; when Rₙ is a fixed value, the outage probability of Case2 is smaller than the outage probability of Case1, which shows the superiority of general k-μ shadow fading. Therefore, the performance of the system can be improved by reducing the target rate and adopting more complex and realistic k-μ shadow fading.

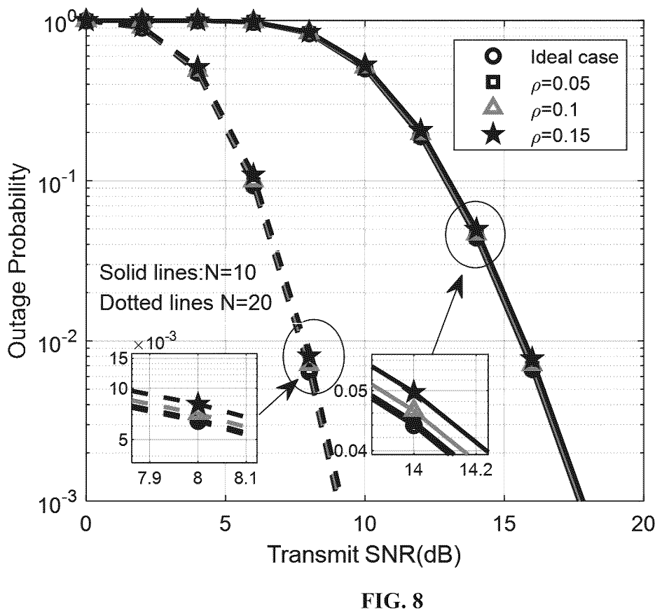

FIG. 8 shows the impact of RHI on the system performance at different N. To compare the effect of RHI on the outrage probability, a curve for the ideal case ρ=0 is drawn as a comparison. In the ideal case, both the transmitter and receiver are not affected by hardware corruption, and the outrage probability is the lowest. As shown in the figure, the presence of RHI decreases the outrage probability of the E-RHI-RIS-NOMA system, and the outrage probability increases gradually with the increase of ρ.

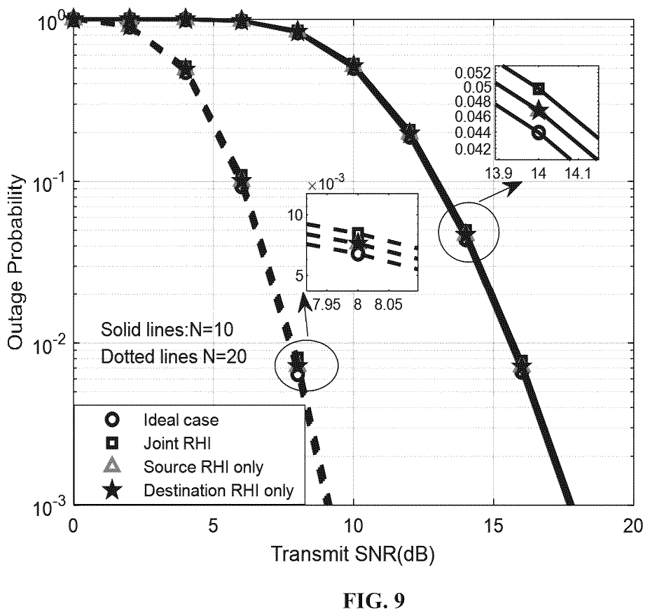

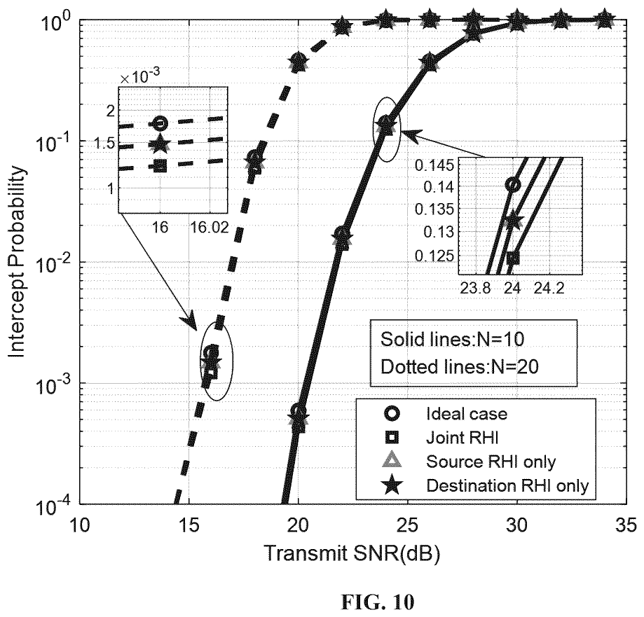

FIG. 9 shows the variation of the outage probability of users Dₙ when RHI exists at different nodes. As shown in the figure, when RHI only occurs in the destination node and the eavesdropping node, the impact on the reliability performance of the system is smaller than that in the case of joint RHI, and it can also be observed that the outrage probability of the system decreases significantly with the increase of N. FIG. 10 shows the variation of the user's intercept probability in the presence of RHI at different nodes. The impact on the system security performance when RHI occurs only at the destination and eavesdropping nodes is greater than that in the case of a joint RHI, and the system's intercept probability increase significantly with increasing N. This suggests that the accurate modeling of the hardware defects of the transmitter and receiver is necessary when evaluating the performance of RIS-assisted NOMA systems.

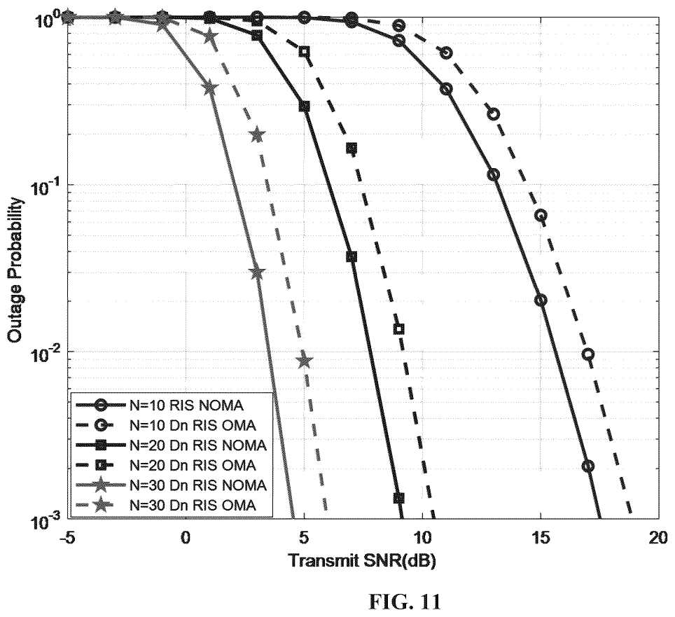

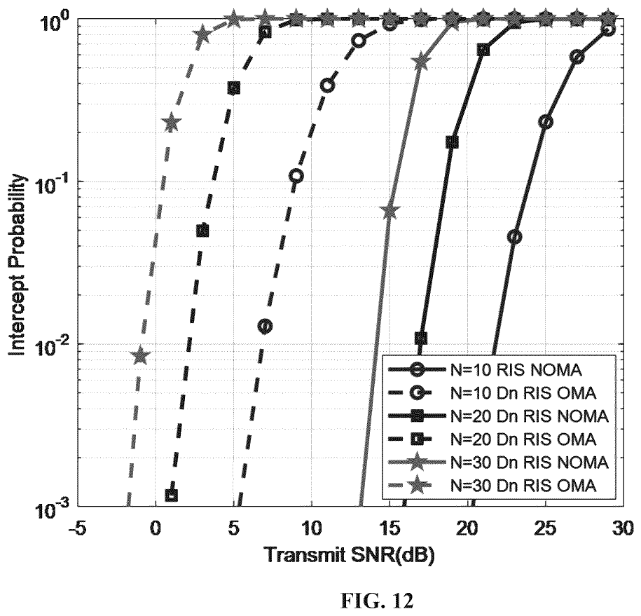

As shown in FIG. 11, it can be seen that when N is the same, the outrage probability of RIS assisted NOMA system is lower than that of RIS assisted OMA system, indicating the former has stronger reliability. As N increases, the outrage probability of both systems gradually decreases. To comprehensively compare the intercept performance of NOMA and OMA systems under different N, as shown in FIG. 12, the intercept probability of RIS assisted NOMA system is lower than that of RIS assisted OMA system, indicating the former has stronger security. As N increases, the intercept probability of both systems gradually increases. Therefore, reasonable deployment of RIS can effectively improve the security and reliability of the OMA and NOMA systems, and RIS assisted NOMA systems are much more advantageous.

It will be obvious to those skilled in the art that changes and modifications may be made, and therefore, the aim in the appended claims is to cover all such changes and modifications.

What is claimed is:

1. A wireless secure communication method using reconfigurable intelligent surface-non-orthogonal multiple access (RIS-NOMA) under complex channel conditions, wherein the RIS-NOMA refers to a RIS-NOMA communication system comprises:
a base station (BS), a reconfigurable intelligent surface (RIS), a legitimate NOMA user, and an eavesdropper (Eve);
the legitimate NOMA user comprises a legitimate remote user Dₘ and a legitimate near user Dₙ, and the base station communicates with the RIS; the RIS communicates with the legitimate NOMA user; the Eve intercepts a signal transmitted by the RIS; an arbitrary channel link obeys K-u shadow fading; each node in the RIS-NOMA communication system encounters a residual hardware impairment (RHI);
the method comprising:
1) calculating a signal to interference plus distortion noise ratio (SIDNR) for the legitimate NOMA user and the eavesdropper in the presence of RHI in the RIS-NOMA communication system;
2) approximating a probability density function and cumulative distribution function for the k-u shadow fading;
3) calculating an outrage probability of the legitimate NOMA user and an intercept probability of the eavesdropper; and
4) transforming a calculation of the outrage probability of the legitimate NOMA user and the intercept probability of the eavesdropper into solving a cumulative distribution function of equivalent channel coefficients of corresponding joint channels, whereby measuring physical layer secure transmission performance of the system.

2. The method of claim 1, wherein 1) is performed as follows:
defining a channel coefficient from the base station to an ith RIS reflecting surface in the system as hₛᵢ, and channel coefficients from the RIS to the legitimate NOMA user and to the eavesdropper as g_{id}_{ᵤ}, u∈(n,m) and gᵢₑ, respectively;
when the legitimate near user Dₙ detects a weak signal xₘ, the signal to interference plus distortion to noise ratio SIDNR is expressed as:
$${γ}_{{D}_{n} \to {D}_{m}} = \frac{{α}_{m} {A}_{n}^{2}}{{A}_{n}^{2} ( {α}_{n} + {ρ}_{{SD}_{n}}^{2} ) + \frac{{d}_{B}^{τ} {d}_{R , n}^{τ}}{{ρ}_{S}}} ; \qquad ( 1 )$$
wherein, αₘ and αₙ represent power distribution coefficients of the legitimate remote user Dₘ and the legitimate near user Dₙ, respectively, and
$${α}_{𝔫} < {α}_{m} ,$$
$${α}_{m} + {α}_{n} = 1 ;$$
$${ρ}_{S} = \frac{{P}_{S}}{{σ}_{D}^{2}}$$
represents an average signal-to-noise ratio of a legal link, Ps is a transmit power of BS, and is an additive white Gaussian noise channel variance; ρ_{SD}_{ₙ} represents an overall RHI level of a link BS→Dₙ; Aₙ=Σᵢ₌₁^{N}|hₛᵢ∥g_{id}_{ₙ}| represents a joint channel coefficient of the link BS→Dₙ; hₛᵢ is a channel coefficient of a link BS→RIS; g_{id}_{ₙ} is a channel coefficient of a link RIS→Dₙ; |·| represents modeling; d_{B} and d_{R,n} represent a distance from the base station to the RIS and a distance from the RIS to the legitimate near user Dₙ, respectively; and τ represents a path fading index;
through SIC technology, the SIDNR of Dₙ decoding its own signal is given by the following equation:
$${γ}_{{D}_{n}} = \frac{{α}_{n} {A}_{n}^{2}}{{A}_{n}^{2} {ρ}_{{SD}_{n}}^{2} + \frac{{d}_{B}^{τ} {d}_{R , n}^{τ}}{{ρ}_{S}}} ; \qquad ( 2 )$$
when Dₘ decodes its own signal, a signal xₙ with strong channel gain is considered as noise, and SIDNR is represented as follows:
$${γ}_{{D}_{m}} = \frac{{α}_{m} {A}_{m}^{2}}{{A}_{m}^{2} ( {α}_{n} + {ρ}_{{SD}_{m}}^{2} ) + \frac{{d}_{B}^{τ} {d}_{R , m}^{τ}}{{ρ}_{S}}} ; \qquad ( 3 )$$
wherein Aₘ=Σᵢ₌₁^{N}|hₛᵢ∥g_{id}_{ₘ}|; g_{id}_{ₘ} is a channel coefficient of a link RIS→Dₘ;
when the eavesdropper intercepts the signals xₙ and xₘ respectively, the obtained SIDNR is expressed as follows:
$${γ}_{{E}_{n}} = \frac{{α}_{n} {A}_{e}^{2}}{{A}_{e}^{2} {ρ}_{SE}^{2} + \frac{{d}_{B}^{τ} {d}_{R , e}^{τ}}{{ρ}_{E}}} \qquad ( 4 )$$
$${γ}_{{E}_{m}} = \frac{{α}_{m} {A}_{e}^{2}}{{A}_{e}^{2} ( {α}_{n} + {ρ}_{SE}^{2} ) + \frac{{d}_{B}^{τ} {d}_{R , e}^{τ}}{{ρ}_{E}}} \qquad ( 5 )$$
$${ρ}_{E} = \frac{{P}_{S}}{{σ}_{E}^{2}}$$
represents SNR of an eavesdropping link; Aₑ=Σᵢ₌₁^{N}|hₛᵢ∥gᵢₑ|; gᵢₑ represents a joint channel coefficient of a link RIS→Eve; σ_{E}² represents an additive white Gaussian noise channel variance of the eavesdropper; ρ_{SE} represents an overall RHI level of a link BS→Eve; and d_{R,e} represents a distance from the RIS to the eavesdropper.

3. The method of claim 2, wherein 2) is performed as follows:
SIDNR of the legitimate NOMA user and the eavesdropper contains Aᵤ=Σᵢ₌₁^{N}|hₛᵢ∥g_{id}_{ᵤ}|, u∈(n,m) and Aₑ=Σᵢ₌₁^{N}|hₛᵢ∥gᵢₑ| as equivalent channel coefficients for corresponding joint channels;
assuming that envelopes |hₛᵢ|, |g_{id}_{ᵤ}|, uε(n,m) and |gᵢₑ|; of all instantaneous channel coefficients are subject to independent and identically distributed k-μ shadow fading, and X represents the envelopes |hₛᵢ|, |g_{id}_{ᵤ}|, u∈(n,m) and |gᵢₑ| of instantaneous channel coefficients, the cumulative distribution functions and probability density functions thereof are represented as follows:
$${F}_{X} ( x ) = \frac{{μ}^{μ - 1} {{m}^{m} ( 1 + k )}^{μ}}{Γ ( μ ) {( μ k + m )}^{m}} {( \frac{1}{R} )}^{2 μ} {x}^{2 μ} {Φ}_{2} ( μ - m , m , μ + 1 ; - \frac{μ ( 1 + k ) {x}^{2}}{{R}^{2}} , - \frac{μ ( 1 + k )}{{R}^{2}} \frac{{mx}^{2}}{μ k + m} ) \qquad ( 6 )$$
$$\begin{matrix}{f}_{X} ( x ) = \frac{2 {μ}^{μ} {{m}^{m} ( 1 + k )}^{μ}}{Γ ( μ ) {( μ k + m )}^{m}} ( \frac{1}{{R}^{2 μ}} ) {x}^{2 μ - 1} \\ {exp ( - \frac{μ ( 1 + k )}{{R}^{2}} {x}^{2} )}_{1} {F}_{1} ( m , μ ; \frac{{μ}^{2} k ( 1 + k )}{( μ k + m ) {R}^{2}} {x}^{2} ) \\ = \frac{2 {a}^{μ}}{Γ ( μ ) {b}^{m}} {x}^{2 μ - 1} {exp ( - ax )}_{1} {F}_{1} ( m , μ ; \frac{{μ}^{2} k ( 1 + k )}{( μ k + m ) {R}^{2}} {x}^{2} )\end{matrix} \qquad ( 7 )$$
Γ(·), Φ₂(·) and ₁F₁(·) are defined as a Gamma function, binary confluence hypergeometric function, and confluence hypergeometric function, respectively;
$$a = \frac{μ ( 1 + k )}{Ω} ,$$
$$b = \frac{μ k + m}{m} ;$$
k is a ratio of a total power of dispersed components to dominant sight components, μ is a total number of multipath clusters, m is a fading degree parameter, and R is an average power of the channel;
to simplify calculation, the cumulative distribution function and probability density function of the k-μ shadow distribution are approximated as follows:
$${F}_{X} ( x ) \approx {( \frac{{α}^{α} {x}^{2 α}}{Γ ( α + 1 ) {R}^{2 a}} )}_{1} {F}_{1} ( α , α + 1 , \frac{- {x}^{2} α}{{R}^{2}} ) \qquad ( 8 )$$
$${f}_{X} ( x ) \approx \frac{2 {α}^{α} {x}^{2 α - 1}}{{R}^{2 α} Γ ( α )} exp ( \frac{- {x}^{2}}{{R}^{2}} α ) ; \qquad ( 9 )$$
$$and$$
$$α = \frac{m {μ ( 1 + k )}^{2}}{m + μ {k}^{2} + 2 mk} .$$

4. The method of claim 3, wherein in 3), the outrage probability of the legitimate NOMA user is calculated as follows:
when a channel capacity of a main channel is less than a set threshold Rᵤ, and u∈(n,m), an interrupt event occurs; Cᵤ=½log₂(1+γ_{D}_{ᵤ}) represents the channel capacity of the main channel, and the outrage probability of a legitimate NOMA user Dᵤ is expressed as follows:
$$\begin{matrix}{P}_{out , n} = Pr \{ {C}_{u} \leq {R}_{u} \} \\ = Pr \{ {γ}_{{D}_{u}} \leq {2}^{2 {R}_{u}} - 1 \} \\ = {F}_{{γ}_{{D}_{u}}} ( {2}^{2 {R}_{u}} - 1 )\end{matrix} \qquad ( 10 )$$
3.1) the outrage probability of the legitimate near user Dₙ:
$$\begin{matrix}{P}_{out , n} = Pr \{ {C}_{n} \leq {R}_{n} \} \\ = {F}_{{γ}_{{D}_{n}}} ( {2}^{2 {R}_{n}} - 1 )\end{matrix} ; \qquad ( 11 )$$
F_{γD}_{ₙ}(x) is expressed as:
$$\begin{matrix}{F}_{{γ}_{{D}_{n}}} ( x ) = Pr \{ {γ}_{{D}_{n}} \leq x \} \\ = Pr \{ \frac{{α}_{n} {A}_{n}^{2}}{{A}_{n}^{2} {ρ}_{{SD}_{n}}^{2} + \frac{{d}_{B}^{τ} {d}_{R , n}^{τ}}{{ρ}_{S}}} \leq x \} \\ = Pr \{ {A}_{n}^{2} \leq \frac{{d}_{B}^{τ} {d}_{R , n}^{τ} x}{{ρ}_{S} ( {α}_{n} - x {ρ}_{{SD}_{n}}^{2} )} \} \\ = {F}_{{A}_{n}} ( \sqrt{\frac{{d}_{B}^{τ} {d}_{R , n}^{τ} x}{{ρ}_{S} ( {α}_{n} - x {ρ}_{{SD}_{n}}^{2} )}} )\end{matrix} \qquad ( 12 )$$
F_{A}_{ₙ}(x) represents a cumulative distribution function of Aₙ;
3.2) the outrage probability of the legitimate remote user Dₘ:
$$\begin{matrix}{P}_{out , m} = Pr \{ {C}_{m} \leq {R}_{m} \} \\ = {F}_{{γ}_{{D}_{m}}} ( {2}^{2 {R}_{m}} - 1 )\end{matrix} \qquad ( 13 )$$
F_{γD}_{ₘ}(x) is expressed as:
$$\begin{matrix}{F}_{{γ}_{{D}_{m}}} ( x ) = Pr \{ {γ}_{{D}_{m}} \leq x \} \\ = Pr \{ \frac{{α}_{m} {A}_{m}^{2}}{{A}_{m}^{2} ( {α}_{n} + {ρ}_{{SD}_{m}}^{2} ) + \frac{{d}_{B}^{τ} {d}_{R , m}^{τ}}{{ρ}_{S}}} \leq x \} \\ = Pr \{ {A}_{m}^{2} \leq \frac{{d}_{B}^{τ} {d}_{R , m}^{τ} x}{{ρ}_{S} ( {α}_{m} - x ( {α}_{n} + {ρ}_{{SD}_{m}}^{2} ) )} \} \\ = {F}_{{A}_{m}} ( \sqrt{\frac{{d}_{B}^{τ} {d}_{R , m}^{τ} x}{{ρ}_{S} ( {α}_{m} - x ( {α}_{n} + {ρ}_{{SD}_{m}}^{2} ) )}} )\end{matrix} \qquad ( 14 )$$
F_{A}_{ₘ}(x) represents a cumulative distribution function of Aₘ.

5. The method of claim 4, wherein in 3), the intercept probability of the eavesdropper is calculated as follows:
when a channel capacity of an eavesdropping channel is greater than a transmission rate, an interception event occurs; C_{E}_{ᵤ}=½log₂(1+γ_{D}_{_{Eu}}) represents the channel capacity of the eavesdropping channel, and the intercept probability that the eavesdropper intercepts a legitimate user's information is denoted as follows:
$$\begin{matrix}{P}_{int , n} = {P}_{r} ( {C}_{{E}_{u}} > {R}_{u} ) \\ = 1 - {P}_{r} ( {C}_{{E}_{u}} \leq {R}_{u} ) \\ = 1 - {P}_{r} ( {γ}_{{E}_{u}} \leq {2}^{2 {R}_{u}} - 1 ) \\ = 1 - {F}_{{γ}_{{E}_{u}}} ( {2}^{2 {R}_{u}} - 1 ) ;\end{matrix} \qquad ( 15 )$$
3.3) the intercept probability when the eavesdropper intercepts the legitimate near user Dₙ:
$$\begin{matrix}{P}_{int , n} = {P}_{r} ( {C}_{{E}_{n}} > {R}_{n} ) \\ = 1 - {P}_{r} ( {C}_{{E}_{n}} \leq {R}_{n} ) \\ = 1 - {F}_{{γ}_{{E}_{n}}} ( {2}^{2 {R}_{n}} - 1 ) ;\end{matrix} \qquad ( 16 )$$
F_{γE}_{ₙ}(x) is expressed as:
$$\begin{matrix}{F}_{{γ}_{{E}_{n}}} ( x ) = Pr \{ {γ}_{{E}_{n}} \leq x \} \\ = Pr \{ \frac{{α}_{n} {A}_{e}^{2}}{{A}_{e}^{2} {ρ}_{SE}^{2} + \frac{{d}_{B}^{τ} {d}_{R , e}^{τ}}{{ρ}_{E}}} \leq x \} \\ = Pr \{ {A}_{e}^{2} \leq \frac{{d}_{B}^{τ} {d}_{R , e}^{τ} x}{{ρ}_{E} ( {α}_{n} - x {ρ}_{SE}^{2} )} \} \\ = {F}_{{A}_{e}} ( \sqrt{\frac{{d}_{B}^{τ} {d}_{R , e}^{τ} x}{{ρ}_{E} ( {α}_{n} - x {ρ}_{SE}^{2} )}} )\end{matrix} \qquad ( 17 )$$
F_{A}_{ₑ}(x) represents a cumulative distribution function of Aₑ;
3.4) the intercept probability when the eavesdropper intercepts the legitimate remote user Dₘ:
$$\begin{matrix}{P}_{int , m} = {P}_{r} ( {C}_{{E}_{m}} > {R}_{m} ) \\ = 1 - {P}_{r} ( {C}_{{E}_{m}} \leq {R}_{m} ) \\ = 1 - {F}_{{γ}_{{E}_{m}}} ( {2}^{2 {R}_{m}} - 1 )\end{matrix} \qquad ( 18 )$$
F_{γE}_{ₘ}(x) is expressed as:
$$\begin{matrix}{F}_{{γ}_{{E}_{m}}} ( x ) = Pr \{ {γ}_{{E}_{m}} \leq x \} \\ = Pr \{ \frac{{α}_{m} {A}_{e}^{2}}{{A}_{e}^{2} ( {α}_{n} + {ρ}_{SE}^{2} ) + \frac{{d}_{B}^{τ} {d}_{R , e}^{τ}}{{ρ}_{E}}} \leq x \} \\ = Pr \{ {A}_{e}^{2} \leq \frac{{d}_{B}^{τ} {d}_{R , e}^{τ} x}{{ρ}_{E} ( {α}_{m} - x ( {α}_{n} + {ρ}_{SE}^{2} ) )} \} \\ = {F}_{{A}_{e}} ( \sqrt{\frac{{d}_{B}^{τ} {d}_{R , e}^{τ} x}{{ρ}_{S} ( {α}_{m} - x ( {α}_{n} + {ρ}_{SE}^{2} ) )}} )\end{matrix} \qquad ( 14 )$$
F_{A}_{ₑ}(x) represents a cumulative distribution function of Aₑ.

6. The method of claim 5, wherein 4) is performed as follows:
given Aᵤ=Σᵢ₌₁^{N}|hₛᵢ∥g_{id}_{ᵤ}|, let Xᵢ=Xᵢ₁Xᵢ₂=|hₛᵢ∥g_{id}_{ᵤ}|, and Aᵤ=Σᵢ₌₁^{N}Xᵢ, approximating PDF and CDF of Aᵤ as follows:
$${f}_{{A}_{u}} ( x ) = {a}_{1} {G}_{1 , 2}^{2 , 0} ( \frac{x}{{a}_{2}} \vert \begin{matrix}- ; {a}_{3} \\ {a}_{4} ; {a}_{5}\end{matrix} ) \qquad ( 20 )$$
$${F}_{{A}_{u}} ( x ) \approx {a}_{1} {a}_{2} {G}_{2 , 3}^{2 , 1} ( \frac{x}{{a}_{2}} \vert \begin{matrix}1 ; {a}_{3} + 1 \\ {a}_{4} + 1 ; {a}_{5} + 1 ; 0\end{matrix} ) , x \geq 0 \qquad ( 21 )$$
$${a}_{1} = \frac{Γ ( {a}_{3} + 1 )}{{a}_{2} Γ ( {a}_{4} + 1 ) Γ ( {a}_{5} + 1 )} \qquad ( 22 )$$
$${a}_{2} = \frac{{a}_{3}}{2} ( {φ}_{4} - 2 {φ}_{3} + {φ}_{2} ) + 2 {φ}_{4} - 3 {φ}_{3} + {φ}_{2} \qquad ( 23 )$$
$${a}_{3} = \frac{4 {φ}_{4} - 9 {φ}_{3} + 6 {φ}_{2} - {μ}_{1}}{- {φ}_{4} + 3 {φ}_{3} - 3 {φ}_{2} + {μ}_{1}} \qquad ( 24 )$$
$${a}_{4} = \frac{{a}_{6} + {a}_{7}}{2} \qquad ( 25 )$$
$${a}_{5} = \frac{{a}_{6} - {a}_{7}}{2} \qquad ( 26 )$$
$${a}_{6} = \frac{{a}_{3} ( {φ}_{2} - {μ}_{1} ) + 2 {φ}_{2} - {μ}_{1}}{{a}_{2}} - 3 \qquad ( 27 )$$
$${a}_{7} = \sqrt{{( \frac{{a}_{3} ( {φ}_{2} - {μ}_{1} ) + 2 {φ}_{2} - {μ}_{1}}{{a}_{2}} - 1 )}^{2} - 4 \frac{{μ}_{1} ( {a}_{3} + 1 )}{{a}_{2}}} \qquad ( 28 )$$
$${φ}_{i} = \frac{{μ}_{i}}{{μ}_{i - 1}} , i \geq 1 \qquad ( 29 )$$
$${μ}_{1} = {\sum }_{i = 1}^{N} {μ}_{1}^{( i )} = N {μ}_{1}^{( i )} \qquad ( 30 )$$
$$\begin{matrix}{μ}_{2} = E [ {( {\sum }_{i = 1}^{N} {X}_{i} )}^{2} ] + 2 {\sum }_{i = 1}^{N - 1} {\sum }_{j = m + 1}^{M} E [ {X}_{i} ] E [ {X}_{j} ] \\ = N {μ}_{2}^{( i )} + 2 ( \begin{matrix}N \\ 2\end{matrix} ) E [ {X}_{i} ] E [ {X}_{j} ] \\ = N {μ}_{2}^{( i )} + N ( N - 1 ) {μ}_{1}^{( i )} {μ}_{1}^{( i )}\end{matrix} \qquad ( 31 )$$
where, E[·] represents expectation;
$$\{ \begin{matrix}N \geq 3 , \\ \begin{matrix}{μ}_{3} = E [ {( {\sum }_{i = 1}^{N} {X}_{i} )}^{3} ] = {\sum }_{i = 1}^{N} E [ {X}_{i}^{3} ] + \\ 3 {\sum }_{i = 1}^{N} {\sum }_{{j = 1}_{j \neq i}}^{N} E [ {X}_{i} ] E [ {X}_{j}^{2} ] + 6 {\sum }_{i = 1}^{N - 2} {\sum }_{j = i + 1}^{N - 1} {\sum }_{k = j + 1}^{N} E [ {X}_{i} ] E [ {X}_{j} ] E [ {X}_{k} ] = \\ N {μ}_{3}^{( i )} + 3 N ( N - 1 ) {μ}_{1}^{( i )} {μ}_{2}^{( i )} + N ( N - 1 ) ( N - 2 ) {μ}_{1}^{( i )} {μ}_{1}^{( i )} {μ}_{1}^{( i )}\end{matrix} \\ N = 2 , \\ {μ}_{3} = 2 {μ}_{3}^{( i )} + 3 \times 2 {μ}_{1}^{( i )} {μ}_{2}^{( i )} \\ N = 1 , \\ {μ}_{3} = {μ}_{3}^{( i )}\end{matrix} \qquad ( 32 )$$
$$\{ \begin{matrix}N \geq 4 , \\ \begin{matrix}{μ}_{4} = E [ {( {\sum }_{i = 1}^{N} {X}_{i} )}^{4} ] = {\sum }_{i = 1}^{N} E [ {X}_{i}^{4} ] + 6 {\sum }_{i = 1}^{N - 1} {\sum }_{j = i + 1}^{N} E [ {X}_{i}^{2} {X}_{j}^{2} ] + \\ 4 {\sum }_{i = 1}^{N} {\sum }_{{j = 1}_{j \neq i}}^{N} E [ {X}_{i}^{3} {X}_{j} ] + 12 {\sum }_{i = 1}^{N} {\sum }_{{j = 1}_{j \neq i}}^{N} {\sum }_{{k > j}_{k \neq i}}^{N} E [ {X}_{i}^{2} {X}_{j} {X}_{k} ] + \\ + 24 {\sum }_{i < j < k < l} E [ {X}_{i} {X}_{j} {X}_{k} {X}_{l} ] = N {μ}_{4}^{( i )} + 3 N ( N - 1 ) {μ}_{2}^{( i )} {μ}_{2}^{( i )} + \\ 4 N ( N - 1 ) {μ}_{3}^{( i )} {μ}_{1}^{( i )} + 6 N ( N - 1 ) ( N - 2 ) {μ}_{2}^{( i )} {μ}_{1}^{( i )} {μ}_{1}^{( i )} + \\ N ( N - 1 ) ( N - 2 ) ( N - 3 ) {μ}_{1}^{( i )} {μ}_{1}^{( i )} {μ}_{1}^{( i )} {μ}_{1}^{( i )}\end{matrix} \\ N = 3 , \\ \begin{matrix}{μ}_{4} = 3 {μ}_{4}^{( i )} + 6 {\sum }_{i = 1}^{2} {\sum }_{j = i + 1}^{3} E [ {X}_{i}^{2} {X}_{j}^{2} ] + 4 {\sum }_{i = 1}^{3} {\sum }_{j = 1}^{3} E [ {X}_{i}^{3} {X}_{j} ] + \\ + 12 ( E [ {X}_{1}^{2} {X}_{2} {X}_{3} ] + E [ {X}_{2}^{2} {X}_{1} {X}_{3} ] + E [ {X}_{3}^{2} {X}_{1} {X}_{2} ] ) = \\ 3 {μ}_{4}^{( i )} + 24 {μ}_{1}^{( i )} {μ}_{3}^{( i )} + 18 {μ}_{2}^{( i )} {μ}_{2}^{( i )} + 36 {μ}_{2}^{( i )} {μ}_{1}^{( i )} {μ}_{1}^{( i )}\end{matrix} \\ N = 2 , \\ \begin{matrix}{μ}_{4} = 2 {μ}_{4}^{( i )} + 4 ( E [ {X}_{1} ] E [ {X}_{2}^{3} ] + E [ {X}_{2} ] E [ {X}_{1}^{3} ] ) + 6 E [ {X}_{1}^{2} ] E [ {X}_{2}^{2} ] = \\ 2 {μ}_{4}^{( i )} + 8 {μ}_{1}^{( i )} {μ}_{3}^{( i )} + 6 {μ}_{2}^{( i )} {μ}_{2}^{( i )}\end{matrix} \\ N = 1 , \\ {μ}_{4} = {μ}_{4}^{( i )}\end{matrix} ; \qquad ( 33 )$$
to obtain a₁, a₂, a₃, a₄, first four moments of μₗ are calculated, and μₗ⁽ⁱ⁾ (1≤l≤4) of a variable Aᵤ, is first calculated:
$${μ}_{1}^{( i )} i = E [ {X}_{i} ] = E [ {X}_{i 1} {X}_{i 2} ] = E [ \vert {h}_{si} \vert \vert {g}_{{id}_{k}} \vert ] = E [ \vert {h}_{si} \vert ] E [ \vert {g}_{{id}_{k}} \vert ] \qquad ( 34 )$$
$${μ}_{2}^{( i )} = E [ {X}_{i}^{2} ] = E [ {X}_{i 1}^{2} {X}_{i 2}^{2} ] = E [ {\vert {h}_{si} \vert}^{2} {\vert {g}_{{id}_{k}} \vert}^{2} ] = E [ {\vert {h}_{si} \vert}^{2} ] E [ {\vert {g}_{{id}_{k}} \vert}^{2} ] \qquad ( 35 )$$
$${μ}_{3}^{( i )} = E [ {X}_{i}^{3} ] = E [ {X}_{i 1}^{3} {X}_{i 2}^{3} ] = E [ {\vert {h}_{si} \vert}^{3} {\vert {g}_{{id}_{k}} \vert}^{3} ] = E [ {\vert {h}_{si} \vert}^{3} ] E [ {\vert {g}_{{id}_{k}} \vert}^{3} ] \qquad ( 36 )$$
$${μ}_{4}^{( i )} = E [ {X}_{i}^{4} ] = E [ {X}_{i 1}^{4} {X}_{i 2}^{4} ] = E [ {\vert {h}_{si} \vert}^{4} {\vert {g}_{{id}_{k}} \vert}^{4} ] = E [ {\vert {h}_{si} \vert}^{4} ] E [ {\vert {g}_{{id}_{k}} \vert}^{4} ] . \qquad ( 37 )$$

7. The method of claim 6, wherein the μₗ⁽ⁱ⁾ (1≤l≤4) of a variable Aᵤ is calculated as follows:
firstly, calculating the expectations of Xᵢ₁ and Xᵢ₂, and calculating the expectation of f_{X}_{ᵢ₁}(x) as follows:
$$\begin{matrix}E [ \vert {h}_{si} \vert ] = E [ \vert {g}_{{id}_{k}} \vert ] = {\int }_{0}^{∞} {xf}_{{X}_{i 1}} ( x ) dx \\ = {\int }_{0}^{∞} x \frac{2 {α}^{α} {x}^{2 α - 1}}{{R}^{2 α} Γ ( α )} exp ( \frac{- {x}^{2}}{{R}^{2}} α ) dx \\ = \frac{{{α}^{α} ( \frac{α}{{R}^{2}} )}^{- 0.5 - α} {R}^{- 2 α} Γ ( 0.5 + α )}{Γ ( α )}\end{matrix} \qquad ( 38 )$$
substituting formula (38) into formula (34), to yield:
$${μ}_{1}^{( i )} = {( \frac{{{α}^{α} ( \frac{α}{{R}^{2}} )}^{- 0.5 - α} {R}^{- 2 α} Γ ( 0.5 + α )}{Γ ( α )} )}^{2} \qquad ( 39 )$$
parsing processes of μ₂⁽ⁱ⁾, μ₃⁽ⁱ⁾, μ₄⁽ⁱ⁾ are the same as that of μₗ⁽ⁱ⁾:
$${μ}_{2}^{( i )} = {( {{α}^{α} ( \frac{α}{{R}^{2}} )}^{- α} {R}^{2 - 2 α} )}^{2} \qquad ( 40 )$$
$${μ}_{3}^{( i )} = {( \frac{{{α}^{α} ( \frac{α}{{R}^{2}} )}^{- 1.5 - α} {R}^{- 2 α} Γ ( 1.5 + α )}{Γ ( α )} )}^{2} \qquad ( 41 )$$
$${μ}_{4}^{( i )} = {( \frac{{α}^{α} ( 1 + α ) {( \frac{α}{{R}^{2}} )}^{- 2 - α} {R}^{- 2 α} Γ ( 1 + α )}{Γ ( α )} )}^{2} \qquad ( 42 )$$
to obtain the outrage probability of the legitimate NOMA user and the intercept probability when the eavesdropper intercepts the information xₙ and xₘ;
$$( 43 )$$
$${P}_{out , n} = {F}_{{A}_{n}} ( \sqrt{\frac{{d}_{B}^{τ} {d}_{R , n}^{τ} ( {2}^{2 {R}_{n}} - 1 )}{{ρ}_{S} ( {α}_{n} - x {ρ}_{{SD}_{n}}^{2} )}} ) = {a}_{1} {a}_{2} {G}_{2 , 3}^{2 , 1} ( \frac{\sqrt{\frac{{d}_{B}^{τ} {d}_{R , n}^{τ} ( {2}^{2 {R}_{n}} - 1 )}{{ρ}_{S} ( {α}_{n} - ( {2}^{2 {R}_{n}} - 1 ) {ρ}_{{SD}_{n}}^{2} )}}}{{a}_{2}} \vert \begin{matrix}1 ; {a}_{3} + 1 \\ {a}_{4} + 1 ; {a}_{5} + 1 ; 0\end{matrix} )$$
$$( 44 )$$
$${P}_{out , m} = {F}_{{A}_{m}} ( \sqrt{\frac{{d}_{B}^{τ} {d}_{R , m}^{τ} x}{{ρ}_{S} ( {α}_{m} - x ( {α}_{n} + {ρ}_{{SD}_{m}}^{2} ) )}} ) = {a}_{1} {a}_{2} {G}_{2 , 3}^{2 , 1} ( \frac{\sqrt{\frac{{d}_{B}^{τ} {d}_{R , m}^{τ} ( {2}^{2 {R}_{m}} - 1 )}{{ρ}_{S} ( {α}_{m} - ( {2}^{2 {R}_{m}} - 1 ) ( {α}_{n} + {ρ}_{{SD}_{m}}^{2} ) )}}}{{a}_{2}} \vert \begin{matrix}1 ; {a}_{3} + 1 \\ {a}_{4} + 1 ; {a}_{5} + 1 ; 0\end{matrix} )$$
$$\begin{matrix}{P}_{int , n} = 1 - {P}_{r} ( {C}_{{E}_{n}} \leq {R}_{n} ) \\ = 1 - {F}_{{γ}_{{E}_{n}}} ( {2}^{2 {R}_{n}} - 1 ) \\ = 1 - {F}_{{A}_{e}} ( \sqrt{\frac{{d}_{B}^{τ} {d}_{R , e}^{τ} ( {2}^{2 {R}_{n}} - 1 )}{{ρ}_{E} ( {α}_{n} - ( {2}^{2 {R}_{n}} - 1 ) {ρ}_{SE}^{2} )}} ) \\ = 1 - {a}_{1} {a}_{2} {G}_{2 , 3}^{2 , 1} ( \frac{\sqrt{\frac{{d}_{B}^{τ} {d}_{R , e}^{τ} ( {2}^{2 {R}_{n}} - 1 )}{{ρ}_{E} ( {α}_{n} - ( {2}^{2 {R}_{n}} - 1 ) {ρ}_{SE}^{2} )}}}{{a}_{2}} \vert \begin{matrix}1 ; {a}_{3} + 1 \\ {a}_{4} + 1 ; {a}_{5} + 1 ; 0\end{matrix} )\end{matrix} \qquad ( 45 )$$
$$( 46 )$$
$$\begin{matrix}{P}_{int , m} = 1 - {P}_{r} ( {C}_{{E}_{m}} \leq {R}_{m} ) \\ = 1 - {F}_{{γ}_{{E}_{m}}} ( {2}^{2 {R}_{m}} - 1 ) \\ = 1 - {F}_{{A}_{e}} ( \sqrt{\frac{{d}_{B}^{τ} {d}_{R , e}^{τ} ( {2}^{2 {R}_{m}} - 1 )}{{ρ}_{E} ( {α}_{m} - ( {2}^{2 {R}_{m}} - 1 ) ( {α}_{n} + {ρ}_{SE}^{2} ) )}} ) \\ = 1 - {a}_{1} {a}_{2} {G}_{2 , 3}^{2 , 1} ( \frac{\sqrt{\frac{{d}_{B}^{τ} {d}_{R , e}^{τ} ( {2}^{2 {R}_{m}} - 1 )}{{ρ}_{E} ( {α}_{m} - ( {2}^{2 {R}_{m}} - 1 ) ( {α}_{n} + {ρ}_{SE}^{2} ) )}}}{{a}_{2}} \vert \begin{matrix}1 ; {a}_{3} + 1 \\ {a}_{4} + 1 ; {a}_{5} + 1 ; 0\end{matrix} ) ;\end{matrix}$$
thus completing secure transmission of the physical layer of the system.
